(19) United States
(12) Patent Application Publication
(10) Pub. No.: US 2025/0353378 A1
(43) Pub. Date: Nov. 20, 2025

(54) AUTOMATIC REGENERATIVE BRAKING SYSTEM TO INCREASE ENERGY EFFICIENCY

(71) Applicant: University of South Florida, Tampa, FL (US)

(72) Inventors: Hamed FAGHIHIAN, Tampa, FL (US); Arman SARGOLZAEI, Tampa, FL (US)

(21) Appl. No.: 19/207,801

(22) Filed: May 14, 2025

Related U.S. Application Data
(60) Provisional application No. 63/647,363, filed on May 14, 2024.

(51) Int. Cl. B60L 7/26; B60K 17/08; B60L 3/12; B60Q 9/00; F16H 61/66

(52) U.S. Cl. CPC B60L 7/26; B60K 17/08; B60L 3/12; B60Q 9/00; F16H 61/66; B60L 2240/12; B60L 2240/421; B60L 2240/423; B60L 2240/463; B60L 2240/62; F16H 2061/6605

(57) ABSTRACT

A regenerative braking system includes an electric machine coupled to a wheel of the vehicle. The system includes a distance sensor configured to provide distance information (e.g., a stop location), a torque sensor configured to provide torque information between the electric machine and the wheel, and a speed sensor configured to provide speed information indicative of a speed of the electric machine or a speed of the vehicle. A controller includes a processor and a memory storing instructions executable by the processor to: send a query to a stored map that includes energy efficiency information corresponding to the vehicle, the query including the distance and speed information; output a desired braking torque from the map based on the query and a maximum possible energy efficiency value of the stored map; and control operation of the electric machine based on the torque information and the desired braking torque.

### CROSS-REFERENCE TO RELATED APPLICATIONS

This application claims the benefit of and priority to U.S. Provisional Patent Application No. 63/647,363, filed May 14, 2024, the entire contents of which are incorporated herein by reference.

### BACKGROUND

Traditionally, brake systems are identified as a major source of energy loss in vehicles, contributing to as much as 50% of the total power losses in the traction system. Regenerative Braking Systems (RBS) are known for their ability to enhance vehicle range and reduce energy dissipation as heat. However, the efficiency of energy recovery in RBS is significantly influenced by driver behavior in human-operated vehicles, road conditions (e.g., stop locations or intersections), or by control algorithms in automated vehicles. Existing systems fail to quantify or correct for these inefficiencies. Therefore, a need exists for improved regenerative braking systems.

### SUMMARY

One implementation of the present disclosure is a system to facilitate regenerative braking of a vehicle. The system includes an electric machine, a distance sensor, a torque sensor, a speed sensor, and a controller. The electric machine (e.g., electric motor/generator) is coupled (e.g., at least indirectly) to a wheel of the vehicle. The distance sensor is coupled to a portion of the vehicle. The distance sensor is configured to provide distance information indicative of a distance to a stop location for the vehicle. The torque sensor is configured to provide torque information indicative of a torque between the electric machine and the wheel. The speed sensor is configured to provide speed information indicative of a speed of the electric machine or a speed of the vehicle. The controller includes a processor and a memory storing instructions thereon that, when executed by the processor, cause the processor to: send a query to a stored map that includes energy efficiency information corresponding to the vehicle, the query including the distance information and the speed information; output a desired braking torque from the map based on the query and a maximum possible energy efficiency value of the stored map; and control operation of the electric machine based on the torque information and the desired braking torque.

In some implementations, the maximum possible energy efficiency value of the stored map or the distance to a stop location is continuously updated as the vehicle moves.

In some implementations, the processor is further configured to identify the stop location of the vehicle, calculate the distance to the identified stop location, and continuously update the distance to the stop location based on the maximum possible energy efficiency value of the stored map.

In some implementations, the distance sensor continuously updates the distance to the stop location, and the speed sensor continuously updated the speed of the electric machine or the speed of the vehicle.

In some implementations, the processor continuously updates a desired braking distance based on the desired braking torque and the speed information and controls operation of the electric machine based on the desired braking distance (e.g., tells a user when to start braking, starts braking, or applies a gear ratio).

In some implementations, the processor: sends a second query to the stored map including updated distance and speed information; outputs an updated desired braking torque from the map based on the second query; and controls operation of the electric machine based on the updated desired braking torque and the torque information.

In some implementations, the processor is further configured to generate a braking procedure based on the desired braking torque.

In some implementations, the processor initiates an alert system (e.g., a HUD on the vehicle) to generate at least one notification based on the braking procedure.

In some implementations, controlling operation of the electric machine includes initiating a brake coupled to the wheel of the vehicle to apply a braking force corresponding to the braking procedure.

In some implementations, controlling operation of the electric machine includes initiating a brake coupled to the wheel of the vehicle to apply a braking force corresponding to the desired braking torque, the brake causing a torque input to the electric machine and a battery coupled thereto.

According to another implementation, a system to facilitate regenerative braking of a vehicle is disclosed. The system includes an electric machine (e.g., electric motor/generator). The system further includes a gearbox coupled between the electric machine and a wheel of the vehicle. The gearbox is controllable to adjust a gear ratio between the electric machine and the wheel. The system further includes a distance sensor coupled to a portion of the vehicle. The distance sensor is configured to provide distance information indicative of a distance to a stop location for the vehicle. The system further includes a torque sensor configured to provide torque information indicative of a torque between the electric machine and the wheel. The system further includes a speed sensor configured to provide speed information indicative of a speed of the electric machine or a speed of the vehicle. The system further includes a controller including a processor and a memory storing instructions thereon that, when executed by the processor, cause the processor to: send a query to a stored map that includes energy efficiency information corresponding to the vehicle, the query including the distance information and the speed information; output a desired braking torque from the map based on the query and a maximum possible energy efficiency value of the stored map; and control operation of the electric machine or the gearbox based on the torque information and the desired braking torque.

In some implementations, the processor controls operation of the gearbox based on the torque information, wherein the torque information is continuously updated during application of a brake to the wheel.

In some implementations, the processor is reactive to application of the brake via a user of the vehicle.

In some implementations, the gearbox is a continuously variable transmission.

In some implementations, the processor further controls operation of the electric machine and the gearbox based on the desired braking torque and the distance to the stop location, the processor configured to cause the gearbox to change the gear ratio to match a desired gear ratio corresponding to the desired braking torque.

In some implementations, the processor is further configured to generate a braking procedure based on the desired braking torque, wherein the braking procedure includes at least one gear ratio of the gearbox.

In some implementations, controlling operation of the electric machine includes initiating a brake coupled to the wheel of the vehicle to apply a braking force corresponding to the desired braking torque, the brake causing a torque input to the electric machine and a battery coupled thereto.

According to another implementation, a method of regenerative braking is disclosed. The method includes providing an electric machine coupled to a wheel of a vehicle. The method further includes providing distance information, via a distance sensor coupled to a portion of the vehicle, indicative of a distance to a stop location for the vehicle. The method further includes providing torque information, via a torque sensor, indicative of a torque between the electric machine and the wheel. The method further includes providing speed information, via a speed sensor, indicative of a speed of the electric machine or a speed of the vehicle. The method further includes sending a query, via a processor of a controller that includes a memory, to a stored map that includes energy efficiency information corresponding to the vehicle, the query including the distance information and the speed information. The method further includes outputting a desired braking torque from the map based on the query and a maximum possible energy efficiency value of the stored map. The method further includes controlling operation of the electric machine based on the torque information and the desired braking torque.

In some implementations, the method further includes performing, via a brake coupled to the vehicle, a braking operation corresponding to the desired braking torque; and recharging a battery coupled to the electric machine based on the braking operation.

In some implementations, the method further includes providing a gearbox coupled between the electric machine and a wheel of the vehicle; and calculating a desired gear ratio based on the distance to the stop location and the desired braking torque; and adjusting the gear ratio of the gearbox.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The systems, methods, and devices are explained in even greater detail in the following drawings. The drawings are merely exemplary and certain features may be used singularly or in combination with other features. The drawings are not necessarily drawn to scale.

FIG. 1A is a diagram of a regenerative braking system, according to one implementation.

FIG. 1B is a diagram of a regenerative braking system, according to another implementation.

FIG. 2 is a controller diagram operable with one or more systems described herein, according to one implementation.

FIG. 3 is a schematic of an electric vehicle with a continuously variable gear ratio, according to one implementation.

FIG. 4 is an illustration of a free body diagram showing relevant forces on a vehicle, according to one implementation.

FIG. 5 shows an energy efficiency map illustrating the power train of an exemplary vehicle based on experimental investigation, according to one implementation.

FIG. 6 shows a proposed controller, according to one implementation.

FIG. 7 shows a dynamic control module, according to one implementation.

FIG. 8 shows an electrical model for a permanent magnet synchronous motor, according to one implementation.

FIG. 9 shows a diagram illustrating rules for an interference mechanism of a fuzzy logic controller based on a simplified energy efficiency map, according to one implementation.

FIG. 10 shows a three-dimensional fuzzy logic map for a designed controller to alter a gear ratio, according to one implementation.

FIG. 11 shows a diagram of a vehicle in an example testing scenario, according to one implementation.

FIG. 12 shows a model of a vehicle powertrain system along with vehicle dynamic, battery model, motor torque control unit, and fuzzy logic gear ratio controller, according to one implementation.

FIG. 13 shows an image of an electric vehicle used in experimental tests and including a plurality of sensors and devices, according to one implementation.

FIG. 14 shows graphs displaying electric vehicle power data from tests where drivers where instructed to accelerate to 10 m/s and 12 m/s, according to one implementation.

FIG. 15 shows graphs displaying speed data from tests where drivers were instructed to accelerate to 10 m/s and 12 m/s, according to one implementation.

FIG. 16 shows a graph modeling human driver behavior in braking based on experimental data, according to one implementation.

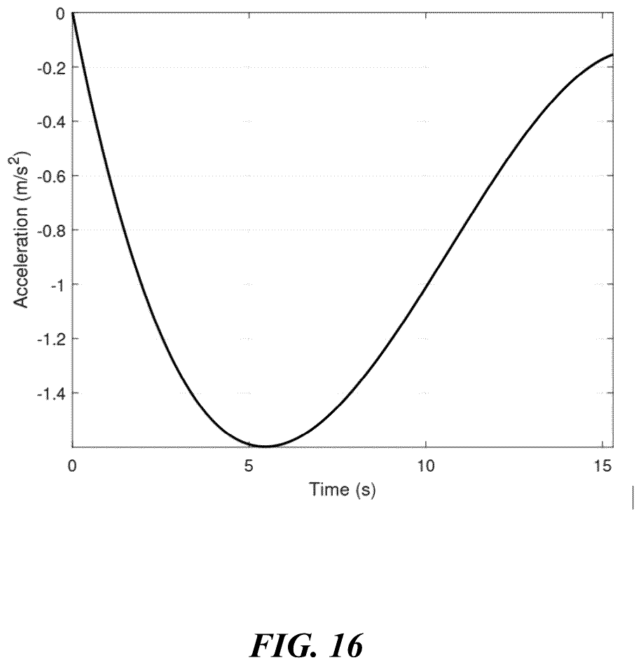

FIG. 17 shows a graph displaying variation in the gear ratio during an automated braking procedure starting from an initial speed of 10 m/s over a distance of 50 meters, according to one implementation.

FIG. 18 shows a diagram of an experimental setup for a hardware in the loop test, according to one implementation.

FIG. 19 shows a graph comparing regenerative braking scenarios, systems, and performance, according to one implementation.

### DETAILED DESCRIPTION

Following below are more detailed descriptions of concepts related to, and implementations of, methods, apparatuses, and systems for regenerative braking. The figures illustrate exemplary implementations in detail and the present disclosure is not limited to the details or methodology set forth in the description or illustrated in the figures. The terminology used herein is for the purpose of description only and should not be regarded as limiting.

Regenerative braking is used in electric and hybrid vehicles to recover energy that would otherwise be lost during braking. Instead of using traditional friction brakes to slow the vehicle, regenerative braking converts the vehicle's kinetic energy into electrical energy and stores it in the battery for later use. For example, when a driver applies the brakes, the electric motor that usually drives the vehicle reverses its operation to act as a generator that converts the kinetic energy of the vehicle into stored electricity in the vehicle's battery. Regenerative braking systems improve energy efficiency and reduce wear on the mechanical braking components. Regenerative braking systems are commonly found in electric vehicles (EVs), hybrid electric vehicles (HEVs), and some plug-in hybrids (PHEVs).

Disclosed herein is a system and method to maximize the recaptured energy from the regenerative braking system. The disclosed method involves determining the optimal braking torque by pre-processing vehicle dynamics and electric powertrain data, aiming to find the most effective braking torque relative to the vehicle's speed and a required distance for a complete stop. A detailed energy efficiency map guides the derivation of the optimal regenerative braking torque, tailored to maximize energy regeneration based on specific vehicle characteristics, proximity to the final stop, and current speed. A comparative analysis between the energy recaptured in standard braking procedures and the proposed braking method reveals a substantial increase in the energy stored in the battery. In some studies, implementation of the proposed RBS enhances real-world urban driving cycle efficiency.

The disclosed system and method can be applied to a wide variety of vehicles (e.g., vehicles equipped with basic connected autonomous vehicles capabilities). As further described herein, one feature of the presented method lies in the creation of an efficiency map for regenerative braking systems, tailored to the specific characteristics of the vehicle and its electric powertrain components. This map serves as a guide for braking commands, taking into account the vehicle's speed and the proximity to its final stopping point. The determination of this stopping point can be achieved through location-sharing technologies or the vehicle's detection mechanisms, such as visual detection systems (camera), radar, or communication devices. In some implementations, the proposed braking system may give priority to the automatic emergency braking system due to safety considerations.

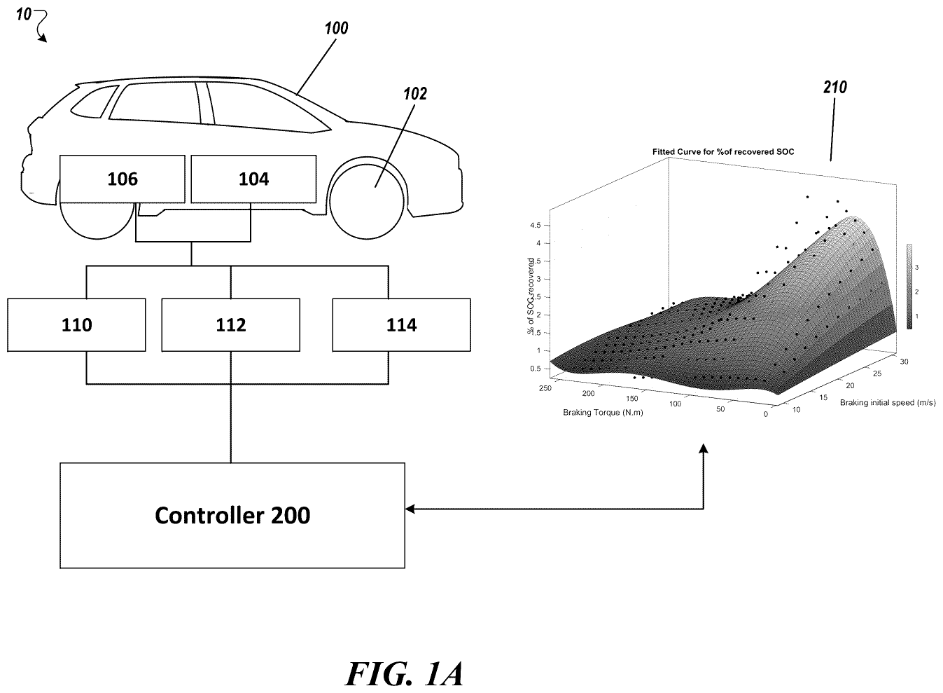

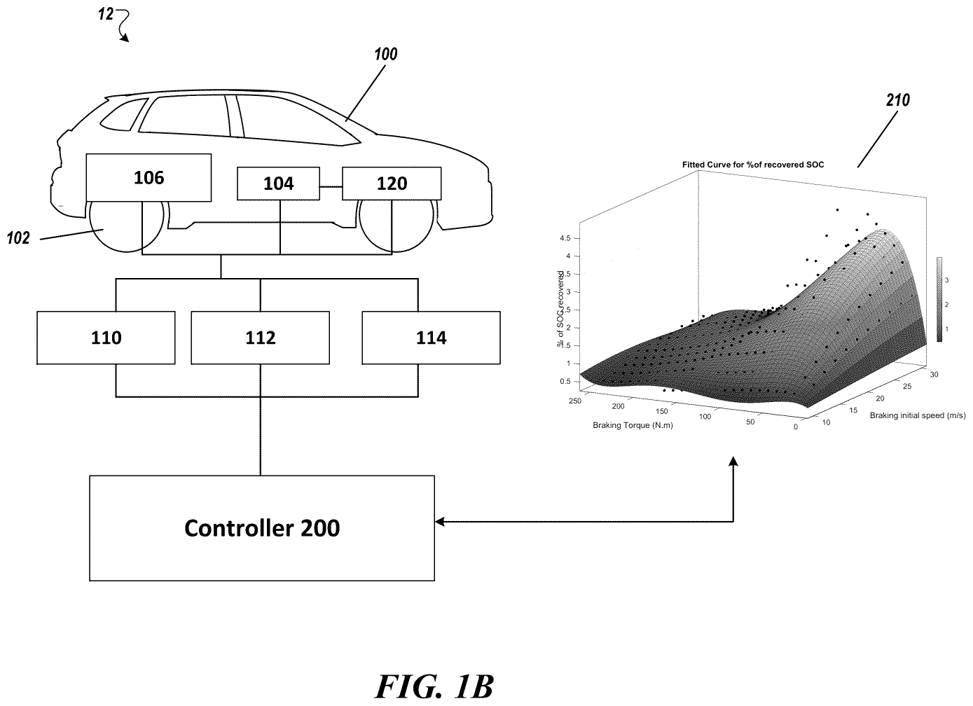

FIG. 1A shows a diagram of a regenerative braking system 10, according to one implementation. As shown, a vehicle 100 is provided (e.g., an electric or hybrid electric vehicle). The vehicle 100 includes one or more wheels 102 (e.g., tires and/or wheels coupled to an axle of the vehicle 100). The vehicle 100 includes an electric machine 104, which may be one or more electric motors of the vehicle. For example, the electric machine 104 may be a single electric motor or more than one electric motor coupled to—either directly or indirectly—the one or more wheels 102 of the vehicle 100. The electric machine 104 is configured to drive the wheels 102 of the vehicle to initiate motion of the vehicle 100. For example, the electric machine 104 is configured to draw power from a battery 106 of the vehicle 100 to apply a torque to the wheels 102. The electric machine 104 is further configured to operate as a generator, taking an applied torque from a moving wheel 102 and converting the kinetic energy into stored energy in the battery 106 (e.g., in a regenerative braking scenario).

The vehicle 100 further includes one or more sensors (e.g., a sensor array) coupled to and in electrical communication with a controller 200. For example, the vehicle 100 includes a distance sensor 110 coupled to the vehicle 100. The distance sensor 110 may include one or more individual distance sensors 110 (e.g., an array of distance sensors) coupled to one or more positions on the vehicle 100. The distance sensor 110 is generally configured to provide distance information about the vehicle 100, such as the distance to a specific point in the external environment. For example, the distance sensor 110 may be configured to provide distance information relative to a stop location for the vehicle 100 (e.g., a stop sign, a traffic light, obstacle, or other stop location). In some implementations described further herein, the stop location may be identified by the controller 200.

The distance sensor 110 may include one or more types of distance sensors. For example, the distance sensor 110 may include an ultrasonic sensor, a radar sensor, a LiDAR (light detection and ranging) sensor, or optical sensors (e.g., camera-based sensors with image processing capabilities). In some implementations, the distance sensor may include one or more devices configured to inform the distance between the vehicle and the stop location. For example, the distance sensor may include one or more communication devices coupled to the vehicle and/or a stop location (e.g., a traffic light pole, bus stop, or other physical infrastructure). In some implementations, remote communication between the one or more communication devices of the distance sensor 110 informs the distance information for the vehicle 100 and the system 10.

The vehicle 100 further includes a torque sensor 112 coupled to a portion of the vehicle 100. The torque sensor 112 may include one or more individual torque sensors 112 (e.g., an array of torque sensors) coupled to one or more positions on the vehicle 100. For example, the torque sensor 112 may be coupled the electric machine 104 and/or the wheels 102. For example, the torque sensor 112 may be configured to sense a value of torque between the wheels 102 and the electric machine 104. In other implementations further described herein, the torque sensor may be coupled to a transmission or gearbox between the wheels and the electric machine.

The torque sensor 112 may include one or more types of torque sensors. For example, the torque sensor 112 may include a rotational torque sensor coupled to a shaft, a reaction torque sensor, a strain gauge torque sensor, or a magnetoelastic torque.

The vehicle 100 further includes a speed sensor 114 coupled to a portion of the vehicle 100 and/or electric machine 104. The speed sensor 114 may include one or more individual speed sensors 114 (e.g., an array of speed sensors) coupled to one or more positions on the vehicle 100. For example, the speed sensor 114 may be configured to provide speed information indicative of the speed of the vehicle 100 along the ground. The speed sensor 114 may be configured to provide speed information indicative of the electric machine 104 and/or the wheels 102, which may be used to derive a speed of the vehicle 100 along the ground.

The speed sensor 114 may include one or more types of speed sensors. For example, the speed sensor 114 may include a speed sensor coupled to a shaft of a motor and/or wheel, a magnetic sensor, a hall effect sensor, or an optical sensor,

The controller 200 of the system 10 is in electrical communication with each of the distance sensor 110, the torque sensor 112, and the speed sensor 114 (e.g., in communication with the sensor array). Thus, the controller 200 can receive and send data between the distance sensor 110, the torque sensor 112, and/or the speed sensor 114, or other elements of the vehicle 100, such as the electric machine 104. In some implementations, the controller is further in communication with a gearbox or transmission.

FIG. 1B shows a regenerative braking system 12 that is substantially similar to the regenerative braking system 10 of FIG. 1A, except as described below. The vehicle 100 of the regenerative braking system 12 includes a gearbox or transmission system configured to shift a gear ratio of the vehicle 100. For example, the gearbox or transmission system may be controllable to adjust a gear ratio between the electric machine 104 and the wheels. In the regenerative braking system 12, the gearbox or transmission system is a continuously variable transmission (CVT) 120. The continuously variable transmission (CVT) 120 provides a range of gear ratios, rather than fixed steps, allowing for efficient and smooth gear ratio adjustment. In other implementations, the system may include any gearbox or transmission system capable of varying a gear ratio between an input and output of a motor or motor system (e.g., continuously).

The CVT 120 is coupled between the electric machine 104 and the wheels 102 of the vehicle 100. The CVT 120 is controllable to adjust a gear ratio between the electric machine 104 and the wheels 102. For example, the CVT 120 is controllably moveable between a range of gear ratios (e.g., controllable via the controller 200).

The processor 202 of the controller 200 is configured to control operation of the CVT 120 based on torque information from the torque sensor 112, wherein the torque information may be continuously updated during a braking operation. In some implementations, the processor 202 is reactive to the application of the brakes from a user of the vehicle 100. For example, the gear ratio may be adjusted during a stopping operation to match a desired braking torque given a user braking input. In other implementations, the processor 202 controls operation of the electric machine 104 based on the desired braking torque and/or the desired stopping distance calculated and/or retrieved from the stored map 210.

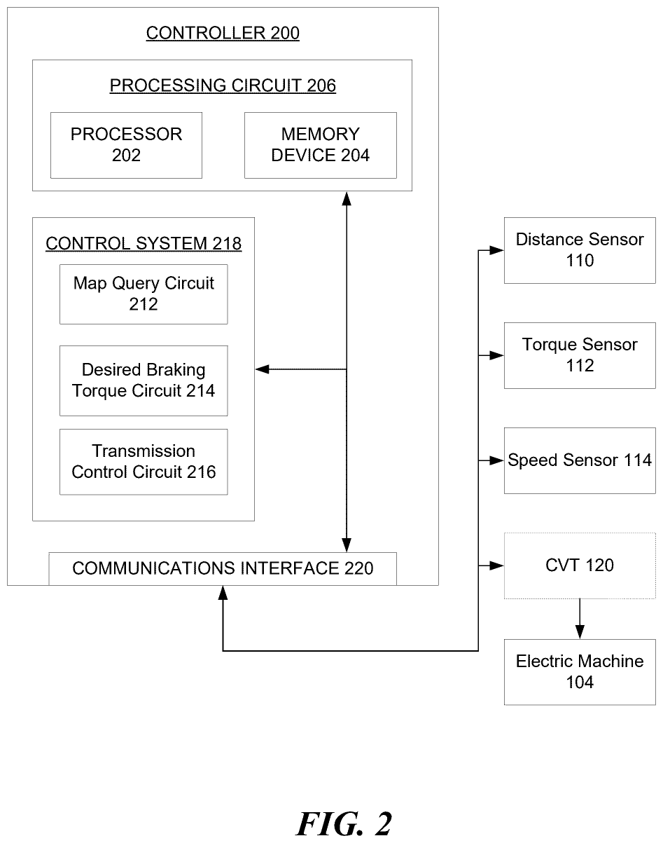

As shown in FIG. 2, a schematic diagram of the controller 200 is shown according to an example implementation. As shown in FIG. 2, the controller 200 includes a processing circuit 206 having a processor 202 and a memory device 204, a control system 218 having a map query circuit 212, a desired braking torque circuit 214, and transmission control circuit 216, and a communications interface 220. Generally, the controller 200 is structured to control the regenerative braking system 10 (or the regenerative braking system 12) to provide and initiate an energy efficient braking operation of the vehicle 100.

In one configuration, the circuits of the control system 218 are in the form of machine or computer-readable media that is executable by a processor, such as processor 202. As described herein, the machine-readable media facilitates performance of certain operations to enable reception and transmission of data. For example, the machine-readable media may provide an instruction (e.g., command, etc.) to acquire data. In this regard, the machine-readable media may include programmable logic that defines the frequency of acquisition of the data (or, transmission of the data). The computer readable media may include code written in any programming language. The computer readable program code may be executed on one processor, multiple co located processors, multiple remote processors, or any combination of local and remote processors. Remote processors may be connected to each other through any type of network (e.g., CAN bus, etc.).

In another configuration, the circuits of the control system 218 are implemented as hardware units, such as electronic control units. As such, the circuits of the control system 218 may be implemented as one or more circuitry components including, but not limited to, processing circuitry, network interfaces, peripheral devices, input devices, output devices, sensors, etc. In some implementations, the circuits of the control system 218 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the circuits of the control system 218 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The circuits of the control system 218 may also include programmable hardware devices such as field programmable gate arrays, programmable array logic, programmable logic devices or the like. The circuits of the control system 218 may include one or more memory devices for storing instructions that are executable by the processor(s) of the circuits of the control system 218. The one or more memory devices and processor(s) may have the same definition as provided below with respect to the memory device 204 and processor 202. In some hardware unit configurations, the circuits of the control system 218 may be geographically dispersed throughout separate locations. Alternatively and as shown, the circuits of the control system 218 may be implemented in or within a single unit/housing, which is shown as the controller 200.

In the example shown, the controller 200 includes the processing circuit 206 having the processor 202 and the memory device 204. The processing circuit 206 may be structured or configured to execute or implement the instructions, commands, and/or control processes described herein with respect to the circuits of the control system 218. The depicted configuration represents the circuits of the control system 218 as machine or computer-readable media. However, as mentioned above, this illustration is not meant to be limiting as the present disclosure contemplates other implementations where the circuits of the control system 218, or at least one circuit of the circuits of the control system 218, is configured as a hardware unit. All such combinations and variations are intended to fall within the scope of the present disclosure.

The hardware and data processing components used to implement the various processes, operations, illustrative logics, logical blocks, modules and circuits described in connection with the implementations disclosed herein (e.g., the processor 202) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some implementations, the one or more processors may be shared by multiple circuits (e.g., the circuits of the control system 218 may comprise or otherwise share the same processor which, in some example implementations, may execute instructions stored, or otherwise accessed, via different areas of memory). Alternatively or additionally, the one or more processors may be structured to perform or otherwise execute certain operations independent of one or more co-processors. In other example implementations, two or more processors may be coupled via a bus to enable independent, parallel, pipelined, or multi-threaded instruction execution. All such variations are intended to fall within the scope of the present disclosure.

The memory device 204 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 204 may be communicably connected to the processor 202 to provide computer code or instructions to the processor 202 for executing at least some of the processes described herein. Moreover, the memory device 204 may be or include tangible, non-transient volatile memory or non-volatile memory. Accordingly, the memory device 204 may include database components, object code components, script components, or any other type of information structure for supporting the various activities and information structures described herein.

In general, the memory 204 includes a stored map 210. The stored map 210 includes predetermined data about the vehicle 100 which informs a regenerative braking operation of the vehicle 100 and the regenerative braking system 10.

For example, the stored map 210 includes energy efficiency information corresponding to the vehicle 100 or a class of vehicles that includes the vehicle 100. The energy efficiency information may be derived experimentally as further described herein. The stored map 210 includes a table, graph, and/or map of information corresponding to a desired braking torque and/or a desired braking distance of the vehicle 100 in order to maximize the energy recovered in the regenerative braking process. The stored map 210 produces a desired (e.g., maximum under the given conditions) braking torque based on the input values of speed and distance to stop from the distance sensor 110 and the speed sensor 114.

The processor 202 is configured to send a query to the stored map 210 that includes the distance information from the stored map 210 and the speed information from the speed sensor 114. The processor 202 then produces an output of a desired braking torque from the stored map 210 based on the input values and a maximum possible energy efficiency value. For example, in some implementations, the theoretical maximum braking torque may not be feasible based on the given distance to stop the vehicle 100 or other factors in the environment. In such a case, the maximum available braking torque given the conditions is output from the stored map 210 and/or the processor 202.

The processor 202 and the controller 200 is further configured to control operation of the electric machine 104 based on the torque information from the torque sensor 112 and the desired braking torque output from the stored map 210. For example, the processor 202 may initiate control of the electric machine 104 of an autonomous vehicle by applying the brakes of the vehicle to match the desired braking torque (e.g., a braking profile over time). In other implementations, the processor 202 may initiate control of the electric machine 104 of the vehicle 100 by providing information to the driver to facilitate the application of the brakes along the desired braking torque (e.g., a braking profile over time). Such information may include visual, auditory, or haptic information delivered to the driver and/or devices near them (e.g., a heads-up-display (HUD) visible on the windshield of the vehicle 100 or a different alert system).

In some implementations, the distance to the stop location is continuously updated, along with the speed of the vehicle 100 and the applied torque to the electric machine 104. In some implementations, the desired braking torque informs a calculated braking distance and, thus, a desired stop location of the vehicle 100. The desired stop location is achieved based on application of the brakes automatically or by the user, depending on the implementation. The continuous braking torque calculation may include more than one query sent to the stored map 210, the second and subsequent queries including updated speed, torque, and distance information.

In one non-limiting example, the map query circuit 212 is structured to receive the distance information from the distance sensor 110, the torque information from the torque sensor 112, and the speed information from the speed sensor 114. The map query circuit 212 generates a query based on the distance information, the torque information, and the speed information. In some implementations, the query includes an ordered string, or other information format that is indicative of the distance information, the torque information and the speed information. In some implementations, the map query circuit 212 preprocesses the distance information, the torque information, and the speed information (e.g., preliminary calculations, model based analysis, machine learning analysis, etc.) before assembling the query. For example, preprocessing can be used to account for environmental conditions, such as weather or road surface conditions, to adjust the desired braking torque values distance values or to otherwise alter the information used in the query. In some implementations, the query is a distance query and is based on the speed information and the torque information. In some implementations, the query is a torque query and is based on the speed information and the distance information.

The stored map 210 includes preconfigured data about the vehicle 100 (e.g., pretrained or predetermined information derived from one or more experimental trials). The stored map 210 specifically includes a map of desired braking torques for the vehicle 100 given a variety of input conditions. In some implementations, the stored map 210 includes a maximum possible energy efficiency value for the desired braking torque and/or the distance to a stop location. In some implementations, the stored map 210 is a three-dimensional map defining a speed axis, a torque axis, and an efficiency axis. In some implementations, the stored map 210 is a three-dimensional map defining a speed axis, a distance axis, and an efficiency axis.

The desired braking torque circuit 214 is structured to receive a map output from the stored map 210 based on the query (e.g., a distance query or a torque query) and communicate with the regenerative braking system 10 including the electric machine 104. In some implementations, the map output includes maximum possible energy efficient values of the stored map 210 to provide a desired braking profile of the vehicle 100. For example, the map output can include a desired braking torque or a desired distance. The map output is then used by the desired braking torque circuit 214 to identify or determine a braking profile. For example, the map output may be used in calculations, models, a machine learning system to determine a braking profile (e.g., when and how to apply the regenerative braking system 10). The braking profile can define the ideal regenerative braking method based on the query assembled by the map query circuit 212. Once generated, the braking profile is compared to the current condition of the vehicle 100 (e.g., the distance information, the torque information, and the speed information) and adjusted. For example, if the maximum possible desired braking torque is not possible given a relatively short distance to stop, the desired braking torque circuit 214 will calculate a different braking profile based on the shorter distance. While the updated profile may recover less energy from the regenerative braking system 10, the vehicle 100 will stop at the desired location. In other words, the desired braking torque circuit 214 will alter the braking profile to match real world requirements while maximizing the efficiency available.

Once the desired braking profile is generated by the desired braking torque circuit 214, the transmission control circuit 216 controls operation of the vehicle 100, including the electric machine 104, based on the desired braking profile. In some implementations, the transmission control circuit 216 applies the maximum stopping force available via the regenerative braking system 10 and is configured to automatically apply service brakes of the vehicle 100 to match the desired braking profile. For example, the transmission control circuit 216 may initiate application of the service brakes on the wheels 102 based on the given vehicle speed and distance to the stop location. In other implementations, the transmission control circuit 216 may initiate application of the service brakes at a time corresponding to a desired brake application time informed by the desired braking profile. For example, the desired braking torque circuit 214 may calculate a preferred overall distance for the braking operation, and the transmission control circuit 216 may initiate the service braking when the actual distance matches the preferred distance for the braking operation.

In other implementation, the transmission control circuit 216 is configured to inform a user (e.g., driver) to apply the service brakes in alignment with the desired braking profile. For example, the transmission control circuit 216 may initiate an alert system which continuously provides feedback to the user about the vehicle's braking condition as compared to the desired braking profile. The alert system may include a HUD on the windshield displaying how quickly or slowly the vehicle 100 is slowing compared to the desired braking profile. The alert system may alternatively or additionally include a haptic feedback module or an auditory feedback module.

In other implementations, the transmission control circuit 216 is configured to inform and control operation of the gearbox (e.g., CVT 120) of the vehicle 100. The transmission control circuit 216 may calculate a desired gear ratio between the electric machine 104 and the wheels 102 that facilitates application of the desired braking profile. For example, the control system 218 may determine a desired stopping distance and compare a baseline gear ratio to an enhanced gear ratio. In some implementations, (e.g., if the distance to stop is shorter than for a standard operation), the transmission control circuit 216 may increase the gear ratio between the wheels 102 and the electric machine 104 to provide a relatively higher braking torque compared to what normally may be applied. In some implementations, the transmission control circuit 216 continuously adjust the CVT 120 in response to a user-applied braking profile in order to match the desired braking profile.

While various circuits with particular functionality are shown in FIG. 2, it should be understood that the controller 200 may include any number of circuits for completing the functions described herein. For example, the activities and functionalities of the circuits of the control system 210 may be combined in multiple circuits or as a single circuit. Additional circuits with additional functionality may also be included. Further, the controller 200 may further control other activity beyond the scope of the present disclosure. In some implementations, the circuits described herein may include one or more processing circuits comprising one or more memory devices coupled to one or more processors, the one or more memory devices configured to store instructions thereon that, when executed by the one or more processors, cause the one or more processors to perform the operations performed herein and described with reference to circuits.

As mentioned above and in one configuration, the “circuits” may be implemented in machine-readable medium for execution by various types of processors, such as the processor 202 of FIG. 2. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be implemented in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some implementations, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

### Experimental Study and Results—an Energy Efficient Automated Regenerative Braking System

### Introduction

Electric vehicles (EVs) are widely recognized as the future of mobility. Maximizing the energy efficiency of EVs reduces total energy consumption in transportation and addresses challenges related to future EV adoption. Regenerative braking is one of the most promising features for increasing the range and efficiency of EVs. However, the current implementation of regenerative braking relies on human drivers, which is not efficient. Additionally, these systems are not designed to provide efficient torque to maximize the energy efficiency of EVs. To address these challenges, this study proposes an Eco-Regen system which is a novel, energy-efficient automated regenerative braking system (RBS) to increase the energy efficiency of EVs. The proposed system may incorporate a continuously variable gear ratio to maximize recaptured energy during braking maneuvers, with a fuzzy logic controller designed to select the optimum gear ratio in the Eco-Regen system. Human driver behavior was measured to investigate its impact on total recaptured energy during braking, and the effect of average human driver behavior was also studied. Simulation-in-the-loop (SIL) and Hardware-in-the-loop (HIL) results show that the Eco-Regen system can significantly increase the total recaptured energy, by up to 61% compared to an average human driver, especially in scenarios where vehicles operate in environments with frequent stops, such as urban areas or transit buses.

The shift towards EVs in the automotive industry is largely motivated by environmental concerns and economic benefits. Although EVs have garnered significant interest, they have not fully replaced vehicles powered by fossil fuels, primarily due to persistent issues with overall vehicle range limitations, and high charging time. The dilemma of increasing battery size for a longer range versus its environmental and carbon footprint impact continues to be a significant challenge. Moreover, a rise in the adoption of EVs could significantly increase the electricity demand. Overcoming these obstacles could be addressed by increasing the energy efficiency of EVs.

Efforts to boost EVs' energy efficiency are more focused on improving electric motor efficiency, advancing battery thermal management, and optimizing charging strategies. Other techniques such as Eco-Approach and Departure, eco-driving strategies for EV powertrain, or by introducing energy management strategies (EMS) for different driving conditions to control power management unit. Among all of these methods, the regenerative braking system (RBS) is known as one of the most important features. RBS, which significantly increases vehicle range and reduces energy loss as heat, is a key focus in EV design. Traditionally, braking systems are a major source of energy loss, accounting for up to 50% of total power losses in the traction system. Recent developments have led to more efficient RBS, which can store recovered energy in various forms, most notably as electric energy for later use.

Despite numerous studies showing different control methods for maximizing energy recapture in RBS, none considered using an automated braking control system. Existing control methods only considered using a fixed gear ratio in EVs, while some studies show it is possible to increase energy recapture by altering the gear ratio in EVs. To address these challenges, this disclosure proposes utilizing a continuously variable transmission (CVT) gearbox and controlling the gear ratio using a fuzzy logic controller.

Furthermore, the disclosed controllers have been specifically designed to enhance the energy efficiency of RBS. Until now, an automated braking system with a variable gear ratio and a fuzzy logic controller for optimizing regenerative energy have not been explored. This study presents a novel fuzzy logic controller to identify the optimal gear ratio of the CVT, maximizing the total energy recaptured by the RBS. This controller is integrated into an automated multi-level RBS control strategy, specifically designed to enhance EV efficiency. Results clearly illustrated that human driver behavior significantly affects the amount of recaptured energy. Therefore, this study developed a model of an average human driver to investigate the effect on energy efficiency further. The average behavior model was then used to compare automated braking systems and the proposed Eco-Regen method.

### 2. Dynamic Modeling

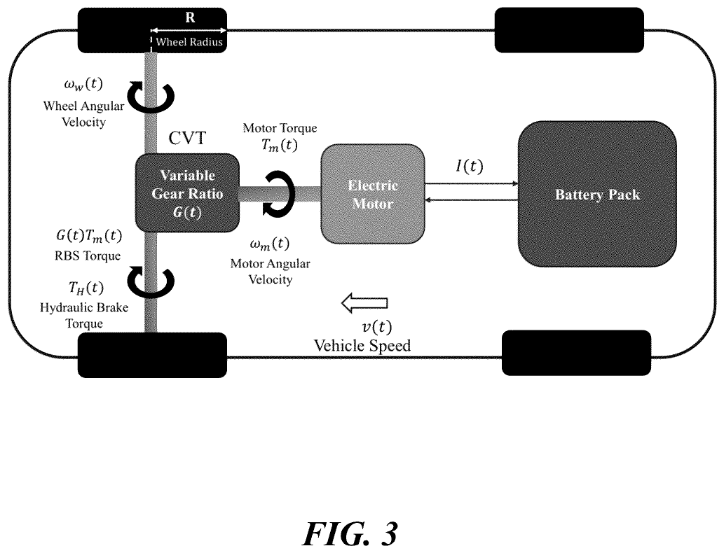

The model of an EV using a permanent magnet synchronous motor (PMSM) and a lithium-ion battery as the only energy source along with the proposed variable gear ratio is depicted in FIG. 3. This section introduces the model of various parts of the vehicle.

### 2.1 Permanent Magnet Synchronous Motor Model

PMSM is an alternative current (AC) machine with a permanent magnet rotor. The stator is excited by three-phase sinusoidal voltages applied to stator windings. The d-q model can introduce equations of PMSM in the rotor reference frame. By using generalized park transformation one can develop equations in the d-q frame. Considering three-phase sinusoidal voltages on the stator windings and using generalized park transformation, the d- and q-axis voltages are defined as

$$\{ \begin{matrix}{v}_{d ( t )} & = {R}_{s} {i}_{d ( t )} + {L}_{d} \frac{{di}_{d}}{dt} - {ω}_{m} ( t ) {L}_{q} {i}_{q} ( t ) \\ {v}_{q ( t )} & = {R}_{s} {i}_{q ( t )} + {L}_{q} \frac{{di}_{q}}{dt} + {ω}_{m} ( t ) ( {L}_{d} {i}_{d} ( t ) + λ )\end{matrix} \qquad ( 1 )$$

where t ∈ [symbol] denotes the time variable in seconds, Rₛ∈ [symbol] is the stator resistance, i_{d}∈ [symbol] and i_{q}∈ [symbol] are the direct axis and the quadrature axis current components, respectively. L_{d}∈ [symbol] and L_{q}∈ [symbol] are the inductance of the direct and quadrature axes, respectively, ωₘ∈ [symbol] denotes the angular velocity of the rotor, and λ∈ [symbol] denotes the flux linkage due to the permanent magnets. Therefore, the PMSM electrical power in the d-q frame can be calculated as

$${P}_{motor} ( t ) = \frac{3}{2} ( {v}_{d} ( t ) {i}_{d} ( t ) + {v}_{q} ( t ) {i}_{q} ( t ) \qquad ( 2 )$$

The general PMSM equation of motion could be written as

$${T}_{m} ( t ) = - 1 \frac{d {ω}_{m} ( t )}{dt} - β {ω}_{m} ( t ) + {T}_{e} ( t ) , \qquad ( 3 )$$

where Tₘ∈ [symbol] represents the load torque applied to the motor shaft, J∈ [symbol] is the moment of inertia of the rotor, and β∈ [symbol] is the viscous friction coefficient. The electromagnetic torque, Tₑ∈ [symbol] , can be calculated as

$${T}_{e} ( t ) = \frac{3}{2} P λ {i}_{d} ( t ) + ( {L}_{d} - {L}_{q} ) {i}_{d} ( t ) {i}_{q} ( t ) \qquad ( 4 )$$

where P∈ [symbol] is the number of pole pairs of the motor.

### 2.2 Vehicle Longitudinal Model

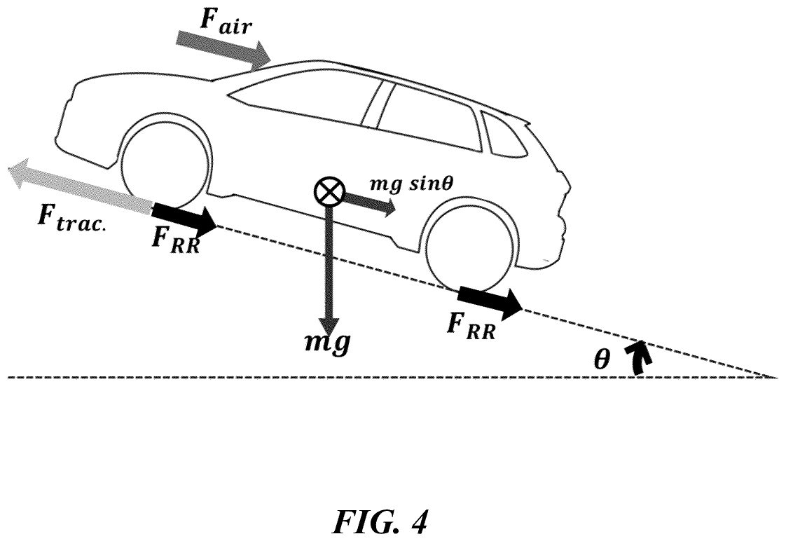

As shown in FIG. 4, the vehicle longitudinal model can be written as

$$M \frac{dv ( t )}{dt} = - mgsin ( θ ( t ) ) - {F}_{air} ( t ) - {F}_{RR} ( t ) + {F}_{trac} ( t ) \qquad ( 5 )$$

where v∈ [symbol] is the vehicle velocity, M∈ [symbol] is the total inertial effects, encompassing both the mass and rotational components of the vehicle's drivetrain and wheels, m∈ [symbol] denotes the mass of the vehicle, and g∈ [symbol] represents the gravitational acceleration. θ∈ [symbol] represents the incline of the road. Fₐᵢᵣ(t) is aerodynamic drag force and can be calculated as

$${F}_{air} ( t ) = \frac{1}{2} {ρ}_{a} {AC}_{D} {v}^{2} \qquad ( 6 )$$

where ρₐ ∈ [symbol] is the air density, A∈ [symbol] is the frontal area of the vehicle, and C∈ [symbol] is the drag coefficient. In addition, F_{RR}(t) is the rolling resistance force which can be described as

$${F}_{RR} ( t ) = mg μ cos ( θ ( t ) ) \qquad ( 7 )$$

where μ∈ [symbol] represents the coefficients of rolling resistance. F_{trac} ∈ [symbol] is the force of traction on the wheel from the ground, which may be positive during the vehicle's acceleration phase or negative in braking. As shown in FIG. 3, the relationship between the motor torque and the tire traction/brake force, with the assumption of the no-slip condition can be written as

$${F}_{trac} ( t ) = \frac{{T}_{trac} ( t )}{T} \qquad ( 8 )$$

where T_{trac} ∈ [symbol] is the total traction or braking torque on wheels and R∈ [symbol] represents wheel radius.

As shown in FIG. 3, by considering the vehicle's electric powertrain-which consists of the electric motor, the gear ratio between the electric motor and drive shafts, and the fact that the drive shafts rotate at the same speed as the wheels-one can use the wheel angular velocity to calculate the vehicle velocity as

$$v ( t ) = R {ω}_{W} ( t ) , \qquad ( 9 )$$

where ω_{w}(t),∈ [symbol] is wheels angular velocity and can be calculated as

$${ω}_{w} ( t ) = \frac{{ω}_{m}^{*} ( t )}{G ( t )} , \qquad ( 10 )$$

where ωₘ*(t)∈ [symbol] is the alternative way of calculating motor angular velocity, and G(t)∈ [symbol] is the gear ratio as shown in FIG. 3. Therefore, by using (9) and (10) one can write

$${ω}_{m} ( t ) = \frac{G ( t ) v ( t )}{R} , \qquad ( 11 )$$

this equation, (11), indicating the powertrain longitudinal model in an EV.

### 2.3 Battery Model

The battery current can be calculated as

$$I ( t ) = \frac{{P}_{bat} ( t )}{{V}_{DC} ( t )} , \qquad ( 12 )$$

where I∈ [symbol] is the battery current, P_{bat}(t)∈ [symbol] is the battery power, and V_{DC}(t)∈ [symbol] is the DC bus voltage. Assuming P_{bat}(t)=Pₘₒₜₒᵣ(t) and by using (2), one can write and by using (2), one can write

$$I ( t ) = \frac{3}{2} \frac{( {v}_{d} ( t ) {i}_{d} ( t ) + {v}_{q} ( t ) {i}_{q} ( t )}{{V}_{DC} ( t )} , \qquad ( 13 )$$

Substituting (1) into (13) can result

$$I ( t ) = \frac{3}{2 {V}_{DC} ( t )} ( {R}_{s} ( {i}_{d}^{2} ( t ) + {i}_{q}^{2} ( t ) ) + {ω}_{m} ( t ) λ {i}_{q} ( t ) . \qquad ( 14 )$$

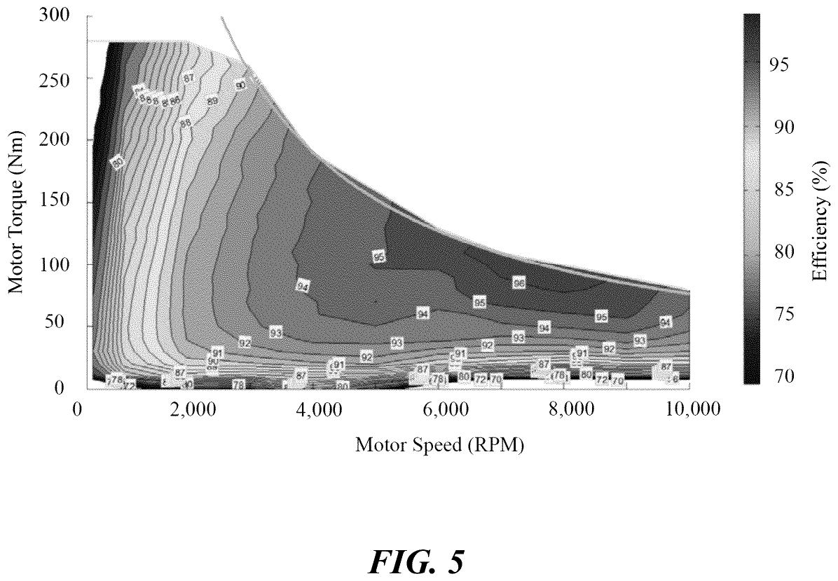

with the assumption of using a Li-ion battery, and neglecting the voltage dynamics of the battery, the battery statement of the charge (SOC) can be calculated as

$$\frac{d}{d t} ( E ( t ) ) = - \frac{1}{η ( t )} \frac{I ( t )}{{Q}_{b}} \qquad ( 15 )$$

where E(t)∈ [symbol] is the battery SOC, η∈ [symbol] is efficiency derived from the energy efficiency map shown in FIG. 5, and Q_{b}∈ [symbol] is the battery capacity.

### 3. Proposed Solution

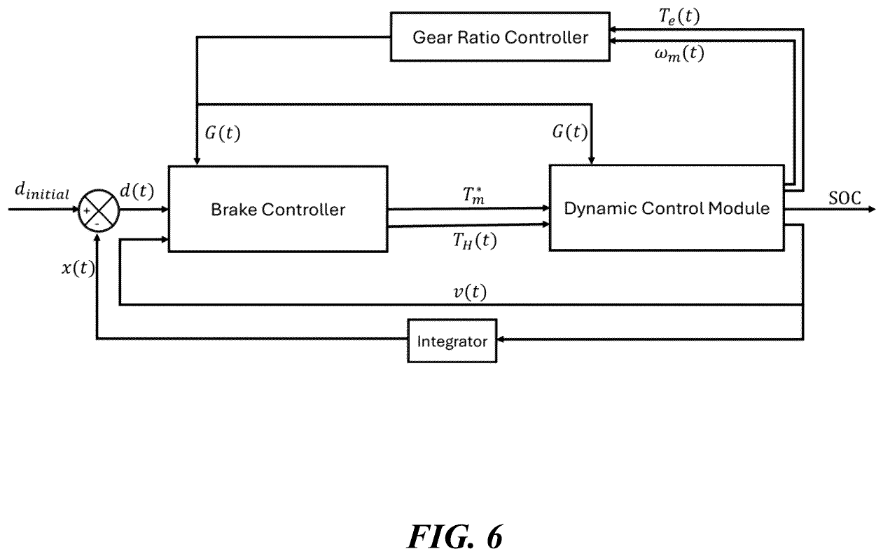

This section discusses a proposed automated braking system to maximize the amount of recaptured energy. The proposed controller is shown in FIG. 6 which includes the brake controller, the dynamic control module, and the gear ratio controller. The brake controller is responsible for providing demand torques for both the hydraulic braking system and the RBS.

The vehicle model in FIG. 6 consists of a PMSM model controlled by the developed motor controller, connected to a power inverter. The PMSM is mechanically coupled to the vehicle powertrain system, as described in Section 3.1. The torque controller of the automated braking system is described in section 3.2, and the gear ratio controller is described in section 3.3.

### 3.1 Dynamic Control Module

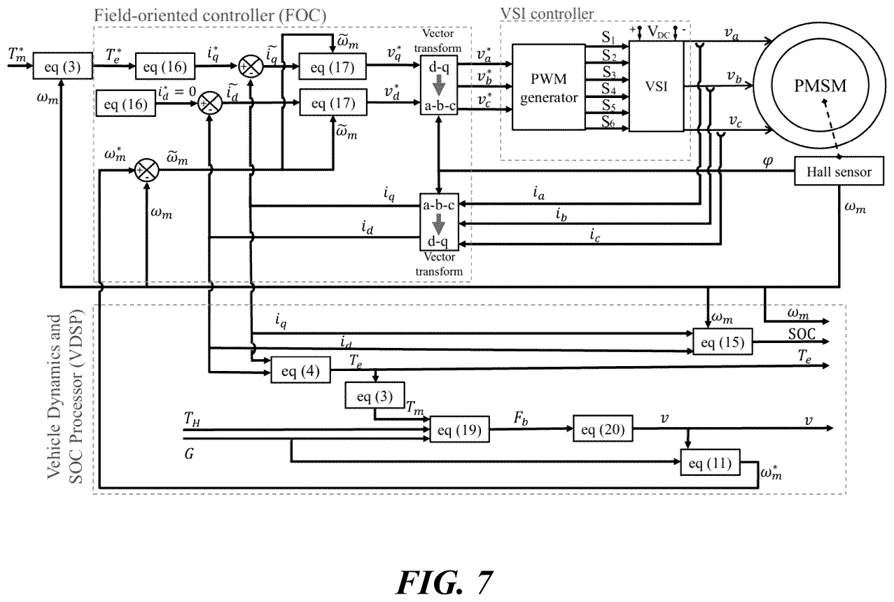

The dynamic control module used here consists of the PMSM, the voltage source inverter (VSI) and VSI controller, the field-oriented controller (FOC), Vehicle dynamics, and SOC processor (VDSP) as depicted in FIG. 7. As shown in FIG. 7, the reference motor torque is one of the input signals of this controller representing the motor load torque, which is used to create desired electromagnetic torque based on, which is the input for FOC.

### 3.1.1 Field Oriented Controller

The basic principles of FOC are based on the detection of the stator phase currents and converting them to the complex d-q vector, rotating with the machine's rotor speed. In the d-q coordinate system, i_{d} is dedicated to control flux linkage, and i_{q} is to control the motor torque. To achieve maximum electromagnetic torque i_{d} should be set to zero. Therefore, the d-q axis reference currents, i_{d}*(t), i_{q}*(t), can be written as

$$\{ \begin{matrix}{i}_{d}^{*} ( t ) = 0 , \\ {i}_{q}^{*} ( t ) = \frac{2}{3 P} ( \frac{{T}_{e}^{*} ( t )}{λ} )\end{matrix} \qquad ( 17 )$$

By using (16) and (1) one can write

$$\{ \begin{matrix}{v}_{d}^{*} ( t ) = - {\tilde{ω}}_{m} ( t ) {L}_{q} {i}_{q}^{*} ( t ) , \\ {v}_{q}^{*} ( t ) = {R}_{s} {i}_{q}^{*} ( t ) + {\tilde{ω}}_{m} ( t ) λ\end{matrix} \qquad ( 18 )$$

Where v_{d}*(t), v_{q}*(t) are reference voltages in d-q coordinate system, \tilde{ω}ₘ [symbol] *(t)-ωₘ(t) is the difference between motor angular velocity from the motor sensor ωₘ(t), and motor angular velocity from the vehicle longitudinal model ωₘ*(t). Reference d-q axis voltages are being converted to three-phase reference voltages, vₐ*, v_{b}*, v_{c}*∈ [symbol] , using park transformation.

### 3.1.2. VSI Controller

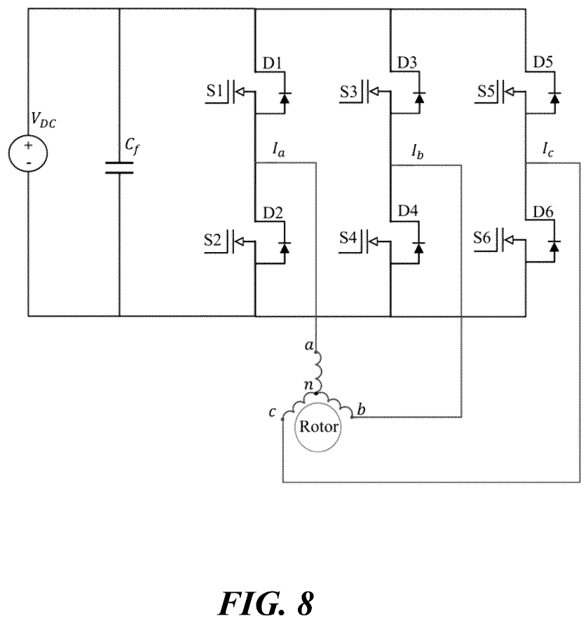

A pulse-width-modulation (PWM) is being sent to a VSI using an efficient bidirectional VSI as the converter for managing both driving and braking modes to apply three-phase reference voltages to the PMSM windings. As shown in FIG. 8, the main supply voltage is from battery representing by V_{DC} with vₐ, v_{b}, v_{c}∈ [symbol] representing back-emfs of the PMSM. S₁ through S₆ denotes power switches, each switch has a freewheeling diode. The DC capacitor C_{f} is located between the battery and switches and is a temporary energy storage.

To utilize maximum efficiency during braking and bring higher torque for high inertia EV braking applications, the regenerative-plugging mode in VSI is utilized to achieve a wider operation range and higher braking torques. This approach merges the plugging braking technique with regenerative braking to achieve motor deceleration. For the VSI controller, the study used the switching pattern described in Table 1.

In the regeneration mode, if S₃ and S₄ switches are on, the current follows from the battery through the motor windings, from node b to node a causing charging the inductor, and while these two switches are off, the current can pass through D₆ and D₁ freewheeling diodes, leading to discharging the inductor and charging the battery.

TABLE 1
VSI commutation timing for regeneration mode of the PMSM

| Hall sensor (a, b, c) | S1 | S3 | S5 | S2 | S4 | S6 |
|---|---|---|---|---|---|---|
| 101 | 0 | 1 | 0 | 1 | 0 | 0 |
| 100 | 0 | 0 | 1 | 1 | 0 | 0 |
| 110 | 0 | 0 | 1 | 0 | 1 | 0 |
| 010 | 1 | 0 | 0 | 0 | 1 | 0 |
| 011 | 0 | 1 | 0 | 0 | 0 | 1 |
| 001 | 0 | 1 | 0 | 0 | 0 | 1 |

### 3.1.3 Vehicle Dynamics and SOC Processor

This part of the dynamic control module is responsible for ensuring the integration of the PMSM with the vehicle's mechanical model and generating output signals. As shown in FIG. 7, the d-q axis currents are used to calculate the motor electromagnetic torque (Tₑ(t)) using (4). By using (3) the motor torque Tₘ(t), can be calculated. In a vehicle using RBS and hydraulic braking, the total braking torque is

$${T}_{b} ( t ) = {T}_{H} ( t ) + G ( t ) {T}_{m} ( t ) \qquad ( 18 )$$

where T_{H}(t)∈ [symbol] is hydraulic braking torque. In braking, the total braking torque is the only traction torque T_{trac}(t)=T_{b}(t), therefore, using (10) and (18), one can calculate total braking force as

$${F}_{b} ( t ) = \frac{G ( t ) {T}_{m} ( t ) + {T}_{H} ( t )}{R} \qquad ( 19 )$$

Considering F_{b}(t)=F_{trac}(t) and substituting (19) (7), and (6) into (5) one can write

$$\dot{v} ( t ) = \frac{G ( {T}_{m} ( t ) + {T}_{H} ( t ) )}{M R} - \frac{m}{M} g sin ( θ ( t ) ) - \frac{1}{2 M} ρ A {C}_{D} {v}^{2} ( t ) - \frac{μ m}{M} g cos ( θ ( t ) ) . \qquad ( 20 )$$

Solving this equation represents the vehicle speed, v(t), which by using (11), one can calculate the motor angular velocity from the vehicle longitudinal model, ωₘ*(t). Also by using (15) one can calculate the battery SOC.

### 3.2 Brake Controller

The brake controller is developed to make sure the vehicle is going to the final exact stop location based on the vehicle speed and location feedback as shown in FIG. 6. The brake controller is designed to calculate hydraulic brake torque and RBS brake torque such that maximizes the RBS utilization ratio.

To find the necessary torque for braking, one can write

$${T}_{n} ( t ) = R m \frac{{v}^{2} ( t )}{2 d ( t )} , \qquad ( 21 )$$

where Tₙ(t)∈ [symbol] is the necessary torque delivered to the vehicles wheels, d∈ [symbol] is the detected distance to the stopping pint.

To maximize the utilization ratio, one should consider that both motor power and motor maximum torque will not be violated. Therefore, one can write

$${T}_{m}^{*} ( t ) = \{ \begin{matrix}\frac{{T}_{n} ( t )}{G ( t )} if \frac{{T}_{n} ( t ) v ( t )}{R} < {P}_{max} \& \frac{{T}_{n} ( t )}{G ( t )} < {T}_{max} , \\ min \{ {T}_{f} , {T}_{max} \} if \frac{{T}_{n} ( t ) v ( t )}{R} > {P}_{max} or \frac{{T}_{n} ( t )}{G ( t )} > {T}_{max}\end{matrix} \qquad ( 22 )$$

where Tₘₐₓ∈ [symbol] is the maximum motor torque, Pₘₐₓ∈ [symbol] is the maximum motor power, T_{f}∈ [symbol] is the feasible motor torque at a given speed and can be calculated as

$${T}_{f} ( t ) = \frac{R {P}_{max}}{G ( t ) v ( t )} , \qquad ( 23 )$$

The desired motor torque as described in (22) and (23) derived such that if the motor can provide enough torque for the braking, this torque will be provided by the motor, if not, the motor torque will set such that the maximum possible power is derived from the motor. Therefore, based on (18) and considering the fact that in braking T_{b}-Tₙ, one can write

$${T}_{H} ( t ) = {T}_{n} ( t ) - G ( t ) {T}_{m}^{*} ( t ) . \qquad ( 24 )$$

Given that, in certain braking scenarios, the motor alone cannot supply the full braking torque, the system is engineered so that the hydraulic brake system compensates for the torque deficit. This ensures that the vehicle can come to a stop at the precise intended location.

### 3.3 Fuzzy Logic Gear Ratio Controller

Described herein is a proposed fuzzy logic Gear Ratio Controller (FLGRC) that is designed to enhance braking performance and energy efficiency in EVs. In many braking maneuvers, the required braking torque exceeds the maximum torque capacity of the electric motor. Consequently, adjusting the gear ratio aids in optimizing the utilization of the RBS. Moreover, as illustrated in FIG. 5, the overall energy efficiency of the powertrain varies across different operational zones. The differences in energy efficiency within each section of the efficiency map suggest that if the braking torque and motor speed are directed towards the zone of maximum energy efficiency, the overall recaptured energy would increase.

The FLGRC is responsible for changing the gear ratio to adjust the amount of the braking torque and motor speed during the braking procedure. The gearbox, which is responsible for this gear ratio as depicted in FIG. 3 is considered CVT. The gear ratio has the opposite effect on motor speed and motor torque for a given set of speed and braking torque, by implementing a fuzzy logic controller that changes the gear ratio the operating zone of PMSM will move to a more efficient zone.

### 3.3.1. Classification of Motor Angular Velocity and Torque

This study systematically classified motor angular velocity and motor torque into six distinct sections each to facilitate a structured analysis and inference mechanism. The motor angular velocity and torque were classified into six sections. This segmentation was determined through expert opinions and the investigation, identifying the minimum number of segments required to maximize recaptured energy while maintaining computational efficiency. The approach ensures higher resolution in the most frequently used operating ranges, enabling precise tuning and control to enhance performance and efficiency. By employing fewer segments in less frequently used ranges, the classification remains straightforward without compromising control quality. The motor angular velocity and torque classification, shown in Table 2, is transformed into membership functions for the designed fuzzy logic controller.

TABLE 2
Motor Angular Velocity and Motor Torque
Membership Functions Range Classification

| | |
|---|---|
| Motor Angular Velocity | Motor Torque |

| Fuzzy | From | To | Fuzzy | From | To |
|---|---|---|---|---|---|
| Label | (RPM) | (RPM) | Label | (Nm) | (Nm) |
| XXS | 0 | 1500 | XXS | 0 | 25 |
| XS | 1500 | 3000 | XS | 25 | 50 |
| S | 3000 | 5000 | S | 50 | 100 |
| M | 5000 | 7000 | M | 100 | 150 |
| L | 7000 | 9000 | L | 150 | 200 |
| XL | 9000 | 11000 | XL | 200 | 250 |

### 3.3.2 Inference Mechanism for Gear Ratio Adjustment

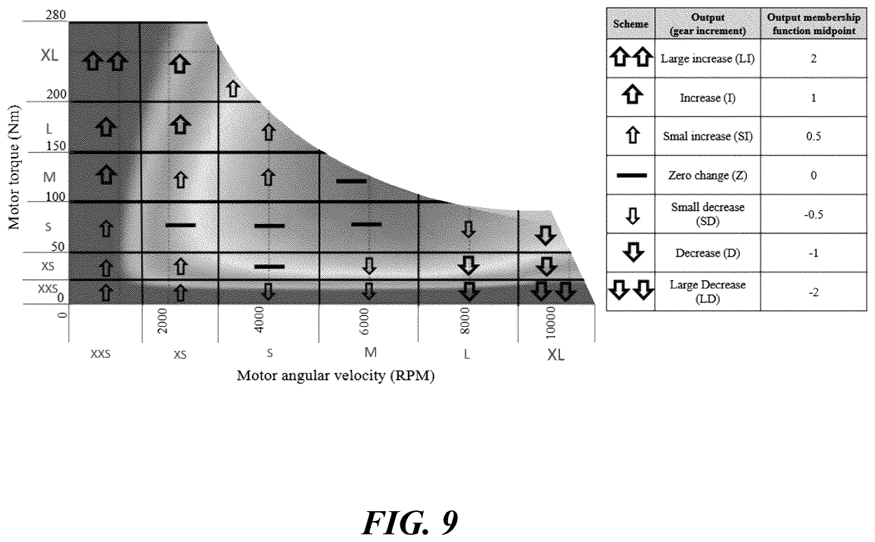

The inference mechanism, illustrated in FIG. 9, determines the necessary adjustment to the gear ratio, G(t), based on the classified motor torque and motor angular velocity using the energy efficiency map of the Nissan Leaf EV powertrain system, as described in FIG. 5.

For instance, when the motor torque falls within the XL region and the angular velocity is classified as XXS, the inference mechanism indicates a significant increase in the gear ratio, denoted by ⬆⬆. This corresponds to a large increase (LI) in the gear ratio. This structured approach ensures a precise and responsive adjustment of the gear ratio, thereby enhancing the efficiency and reliability of the motor system. Moreover, it's important to highlight that at notably low motor speeds, an increase in the gear ratio is advisable to elevate the motor speed, thereby permitting a higher voltage.

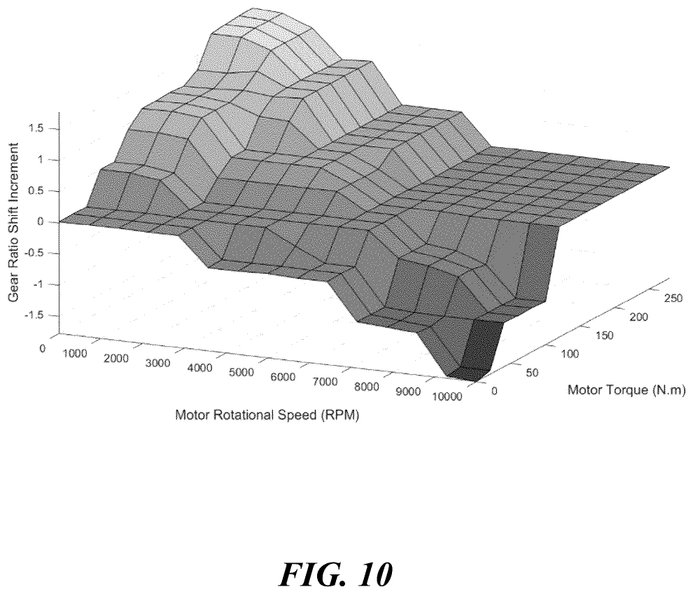

The membership functions for this fuzzy logic controller are shown in FIG. 10. This controller acts as a tuner controller for the gear ratio and its output is an increment or decrement in gear ratio within a physically feasible gear ratio range. The selection of seven levels for gear ratio increments was based on an investigation into the feasibility of gear shifts and the need to minimize controller complexity. To determine the optimal number of output membership functions, the study conducted tests in a similar braking scenario using three, seven, and nine functions and calculated the total recaptured power. The analysis revealed no improvement in control outcomes when increasing the number beyond seven. Therefore, seven membership functions were selected to balance controller complexity and performance.

### 4. Simulation

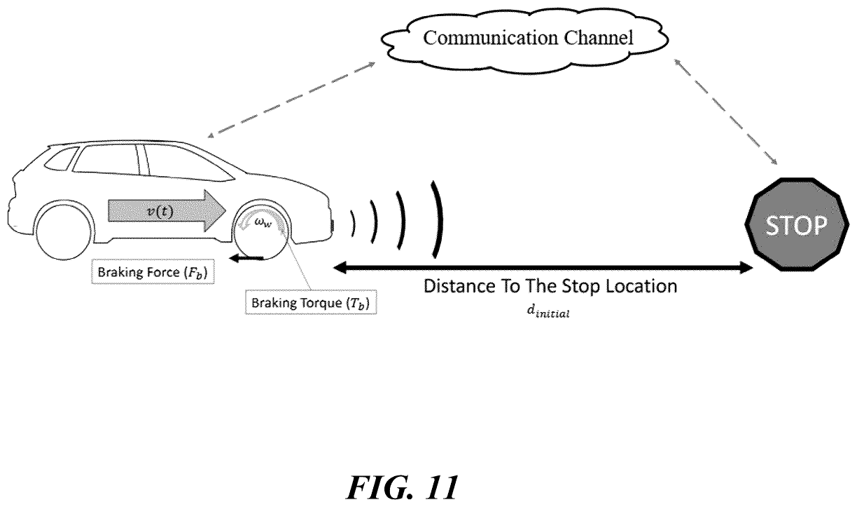

To evaluate the effect of the proposed Eco-Regen system, a test scenario was investigated. The scheme of this scenario is shown in FIG. 11.

The introduced EV can detect stop locations and plan accordingly using onboard sensors or communication systems. This capability may be supported by detection equipment such as radar, LiDAR, or vision-based technologies to enhance distance detection accuracy. Additionally, Vehicle-to-Infrastructure (V2I) communication can be employed to receive stop commands.

At the moment of detection of the stop location, the designed controller shown in FIG. 6, will be activated. Therefore, consider

$$\{ \begin{matrix}t = 0 , \\ x ( t ) = 0 , \\ d ( t ) = {d}_{initial} ,\end{matrix} \qquad ( 25 )$$

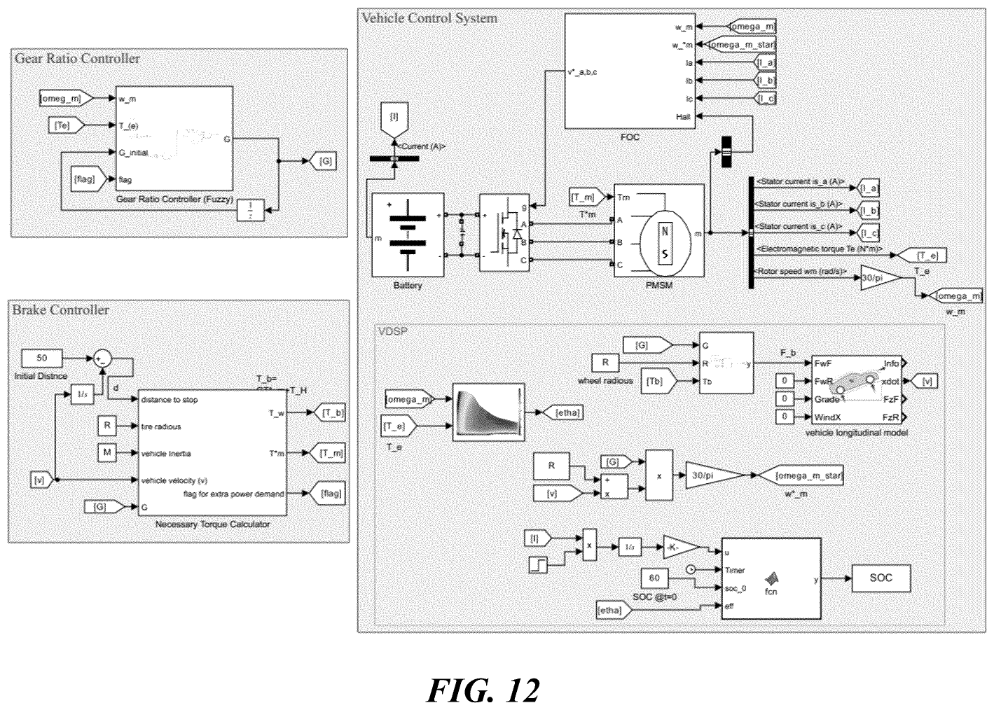

To simulate the whole process, the designed controller along with the dynamic control module and the powertrain model, was simulated using MATLAB/Simulink. The simulated environment in Simulink is shown in FIG. 12.

### 5. Results

In this section, the study first demonstrate the impact of human drivers on the RBS and how their behavior affects the amount of recaptured energy. In Section 5.1, the study shows how a human driver's behavior influences energy recovery during braking. These results are then compared with those obtained when an automated braking controller in the modeled EV with a fixed gear ratio is responsible for making a full stop in Section 5.2. Next, in Section 5.3, the study demonstrated the performance of the designed automated RBS that utilizes a CVT with the proposed FLGRC for making a full stop. The results of these three methods are summarized and discussed in Section 5.5.

The characteristics of the provided model, used for the combined model in FIG. 12, are detailed in Table 3. These parameters, along with the efficiency map shown in FIG. 9, are derived from data corresponding to a commercially available EV, based on information from literature and national laboratory sources.

TABLE 3
Modeled vehicle characteristics

| Parameter | Value | Measuring Index |
|---|---|---|
| Vehicle mass (m) | 1500 | kg |
| Drag Coefficient (C_{D}) | 0.3 | — |
| Vehicle frontal area (A) | 4 | m² |
| Battery capacity (Q_{b}) | 40 | Ah |
| Battery nominal voltage (V_{DC}) | 400 | V |
| Battery response time | 30 | s |
| Initial SOC | 60 | % |
| PMSM torque constant (kₜ) | 1.8 | — |
| PMSM rotary inertia (J) | 0.034 | kgm² |
| Wheel radius (R) | 32.1 | cm |
| Gear ratio (fixed) (G) | 8.193 | — |
| Motor rotational velocity range (ωₘ) | 0-11000 | RPM |
| PMSM torque range (Tₘ) | 0-280 | N · m |
| PMSM maximum power (Pₘₒₜₒᵣ) | 78.5 | KW |
| PMSM phase resistance (Rₛ) | 0.73 | Ω |
| PMSM phase inductance (Lₛ) | 0.003 | H |

### 5.1 Human Driver Behavior

In this subsection, experimental results are presented that investigate the effect of different drivers on energy recaptured with RBS. Then, a model of an average human driver behavior is introduced to evaluate how a human driver would affect RBS effectiveness in different scenarios.

### 5.1.1 Experimental Results: Human Driver Behavior while Using RBS

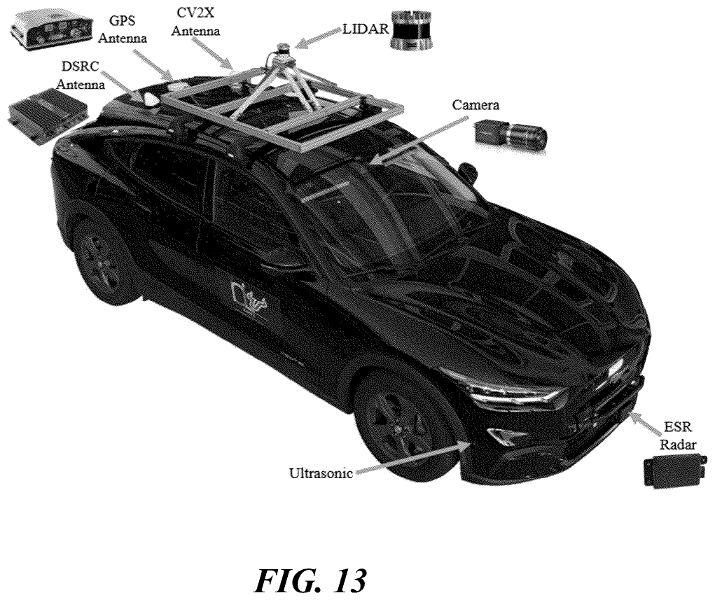

The study conducted the experimental analysis using the EV shown in FIG. 13. The EV was equipped with data-gathering devices, allowing the study to monitor and record the energy transferred to and from the battery during various driving scenarios.

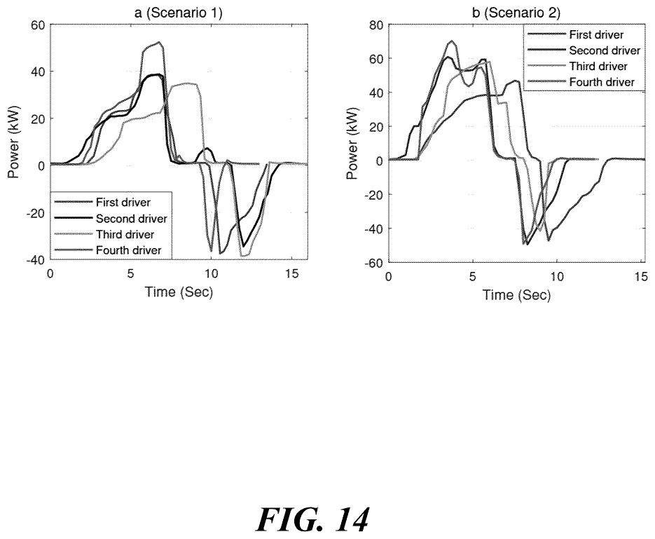

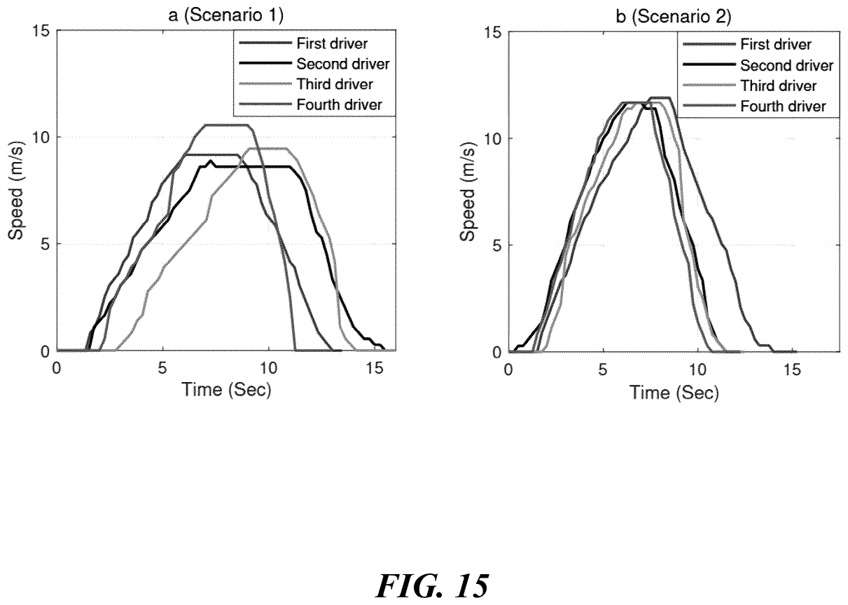

To investigate human driver behavior during braking and stopping, the study conducted experiments on a 250-meter course. Instantaneous power flow to and from the EV motor was measured, with velocity profiles and power data presented in FIGS. 14 and 15. These experiments involved four different drivers across two scenarios. In both scenarios, drivers were instructed to accelerate to a target speed and then stop at a designated point. The target speed was 10 m/s in the first scenario and 12 m/s in the second.

FIG. 14 shows that driver behavior significantly impacts the total recaptured energy during braking. As seen in FIG. 15, although drivers react differently, they tend to brake sharply even when gradual deceleration is enough. The tendency to brake abruptly to reach the final stop with minimal speed reduces the effectiveness of the RBS, leading to less recaptured energy than what could be achieved with optimized braking. Therefore, the conventional hydraulic braking system is used more, which negatively impacts total energy recovery.

Furthermore, the experimental results show that the ratio of recaptured energy to total energy consumed during acceleration across both scenarios and four drivers varies between 15% and 35%. This variation highlights that the effectiveness of the RBS depends more on driver behavior than on the specific experiment conditions.

### 5.1.2 Baseline Model for Human Driver Behavior

As demonstrated in the previous section, human driver behavior is a crucial factor in determining the amount of recaptured energy during braking. While driving habits vary among individuals, simulating the impact of an average driver's behavior on energy recapture requires a mathematical model. To address this, the study utilized a mathematical model to analyze human driver behavior in a simulated environment. Based on the study, human driver behavior before a stop or slowdown is modeled using several behavioral motor primitives. The study employed the primitive that simulates a full stop, aligning with the experimental investigation presented in the previous subsection. This model serves as an estimate of average human driving behavior and is described as

$$a ( t ) = {c}_{2} + {c}_{3} t + \frac{1}{2} {c}_{4} {t}^{2} + \frac{1}{6} {c}_{5} {t}^{3} \qquad ( 26 )$$

where a(t)∈ [symbol] represents acceleration and

$$\{ \begin{matrix}{c}_{2} = {a}_{0} , \\ {c}_{3} = 60 \frac{{s}_{f}}{{T}^{3}} - \frac{360 {v}_{0}}{{T}^{2}} + 3 \frac{{a}_{f} - 3 {a}_{0}}{T} \\ {c}_{4} = - 360 \frac{{s}_{f}}{{T}^{4}} + 192 \frac{{v}_{0}}{{T}^{3}} + 6 \frac{6 {a}_{0} - 4 {a}_{f}}{{T}^{2}} \\ {c}_{4} = 720 \frac{{s}_{f}}{{T}^{5}} - 360 \frac{{v}_{0}}{{T}^{4}} + 60 \frac{6 {a}_{0} - 4 {a}_{f}}{{T}^{3}}\end{matrix} \qquad ( 27 )$$

where s_{f}∈ [symbol] is the total distance to the stop location, a₀ ∈ [symbol] and a_{f}∈ [symbol] is considered as the initial and final acceleration during the braking, and v₀ ∈ [symbol] is the initial velocity. It is clear that the final velocity is going to be zero, and the final acceleration could be calculated as

$${a}_{f} = \frac{3 ( 8 {Tv}_{0} + {a}_{0} {T}^{2} - 20 {s}_{f} )}{{T}^{2} ( 9 + T {ω}_{A} )} \qquad ( 28 )$$

where ω_{A} ∈ [symbol] is the trade-of factor indicating final acceleration. If ω_{A}=0, the final acceleration would have the freedom to adjust and could end up being substantially large. Conversely, if ω_{A}→∞, the final acceleration would be compelled towards zero, necessitating elevated jerk values and consequently diminishing comfort. In this paper, that value for ω_{A} is set to 0.299 based on experiments for a traffic light stop location, however, this value was not chosen based on its impact on comfort. T is the total considered travel time to the final stop location and is calculated as

$$T = \frac{{v}_{0}}{{d}_{v}} \qquad ( 29 )$$

Based on the maximum human driver vision zone is within 75 meters, therefore, s_{f} is assumed to be 75 meters. This method can determine the desired vehicle acceleration, a(t). This acceleration can be converted to necessary braking torque, Tₙ(t), which can be used in (22) to derive desired motor torque, Tₘ*(t), and consequently in (24) to derive hydraulic brake torque, T_{H}(t). The amount of recaptured energy during the braking procedure was investigated and is presented in Table 4 under the human driver section.

### 5.2 Automated Braking with Fixed Gear Ratio

To compare the proposed FLGRC with existing control methods, the study introduced this subsection as a comparative baseline. For this analysis, the study assumed a fixed gear ratio of G=8.1, which represents the baseline state referred to as “automated braking” in Table 4. The results presented in the table demonstrate the advantages of the proposed method over existing controllers in literature. This section extends the research presented in, which was focused on maximizing recaptured energy in an automated RBS.

The automated braking system operates based on the principles described in Section 5. It uses distance feedback from the car to ensure a smooth stop at the designated location, without utilizing any controller to adjust the gear ratio.

### 5.3. Automated Braking with Controlling of Gear Ratio

This section presents the recovered SOC (RSOC) results during braking, considering the designed controller operates the CVT gear ratio between 4 and 30. Simulations here are based on utilizing the maximum possible braking torque out of RBS. The CVT is set such that if the brake controller detects a braking torque beyond the motor's maximum power or maximum torque, the CVT gear ratio will alter so that the electric motor will supply the maximum feasible braking torque. This will guarantee maximum utilization of RBS, which significantly enhances RBS utilization in braking, especially when the EV does not have enough distance toward the stop location. This study refers to this system as the Eco-Regen without CVT and FLGRC, or simply the advanced Eco-Regen.

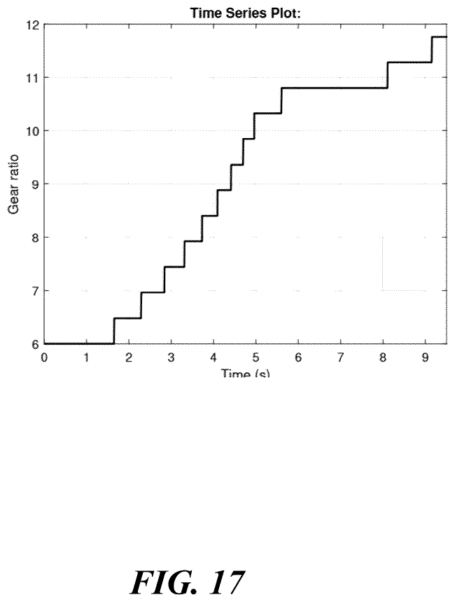

To show how the gear ratio is subjected to change during the braking procedure, FIG. 17 depicts the gear ratio during one of the braking procedures.

### 5.4. Hardware in the Loop (HIL) Implementation

To validate the effectiveness of the proposed Eco-Regen system, the study employed a HIL setup using Speedgoat real-time machine. HIL testing bridges the gap between simulation-based results and practical implementation by enabling real-time evaluation of control algorithms in a realistic environment. The Speedgoat system, integrated with Simulink, provided a high-fidelity platform to replicate the dynamic behavior of an EV. To further support the validity of the data presented in Table 3, identical scenarios were implemented in the HIL environment, and the results are shown in Table 5.

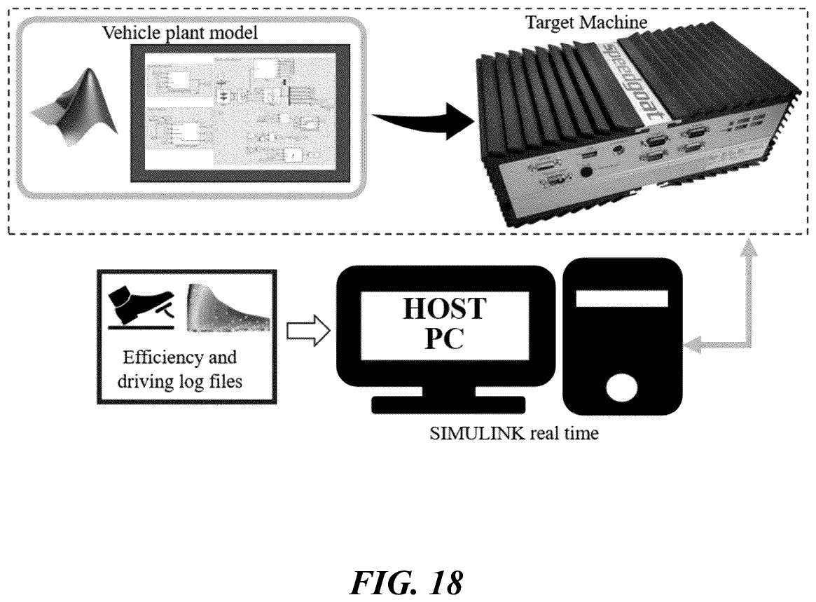

The HIL testing setup was implemented using the Speedgoat Mobile Real-Time Target Machine, equipped with an Intel Celeron 2.7 GHz, 6-core CPU as shown in FIG. 18. This platform seamlessly integrates with MATLAB/Simulink workflows, enabling rapid control prototyping and real-time testing. The HIL system effectively replicated real-time vehicle behavior, including key components such as CVT gearbox dynamics and regenerative braking control strategies. Minor deviations in performance observed during testing were attributed to actuator and sensor delays. These results validate the practical feasibility of the proposed Eco-Regen system for real-world applications.

This HIL setup confirms that the simulation results closely mirror real-world performance. While the results in Table 5 reveal some differences, they still demonstrate that both SIL and HIL converge towards similar outcomes, showing that the approach is practically implementable.

TABLE 4
Results of braking time and recovered SOC in different
braking scenarios using human driver behavior model,
automated braking system with RBS, and automated braking
system with RBS using a CVT with FLGRC.

| Scenario | | Braking Time (BT) and recovered SOC (RSOC) | | | | | |
|---|---|---|---|---|---|---|---|
| Distance | Initial | Human Driver | | Automated | | Proposed Solution | |
| to final | Speed | BT | RSOC | BT | RSOC | BT | RSOC |
| stop (m) | (m/s) | (s) | (%) | (s) | (%) | (s) | (%) |
| 70 | 10 | 14 | 0.035 | 14 | 0.037 | 14 | 0.039 |
| 50 | | 10 | 0.035 | 10 | 0.038 | 10 | 0.039 |
| 30 | | 6 | 0.034 | 6 | 0.036 | 6 | 0.039 |
| 70 | 15 | 9.3 | 0.080 | 9.3 | 0.083 | 9.3 | 0.089 |
| 50 | | 6.7 | 0.079 | 6.7 | 0.075 | 6.7 | 0.090 |
| 30 | | 4 | 0.067 | 4 | 0.064 | 4 | 0.089 |
| 70 | 20 | 8 | 0.125 | 7 | 0.142 | 7 | 0.158 |
| 50 | | 4 | 0.088 | 5 | 0.106 | 5 | 0.143 |
| 30 | | 3 | 0.061 | 3 | 0.064 | 3 | 0.103 |

### 5.5 Discussion

This Paper presented an approach for maximizing regenerated energy in braking. To develop a framework for testing how efficient a braking procedure could become, two approaches were simulated, the first baseline approach uses human driver behavior. The second approach is based on maximizing energy efficiency during a braking procedure using connectivity or detection, but with a fixed gear ratio. The designed approaches prevent any increase in braking time to avoid driver dissatisfaction and potential interruptions. Moreover, longer braking times would reduce traffic flow efficiency and increase overall energy consumption in congested areas.

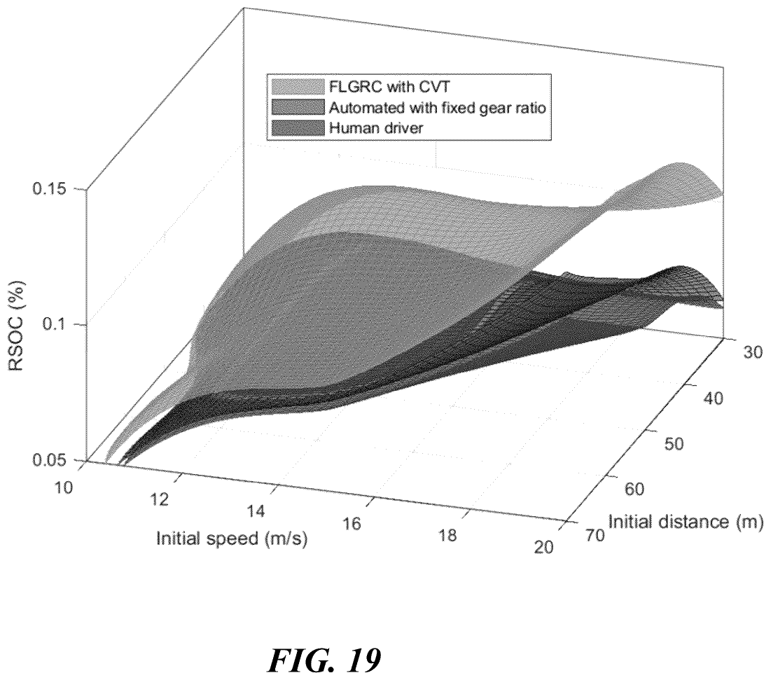

The Eco-Regen can deal with sudden braking situations much better in comparison to other methods as shown in FIG. 19. Recovering even in these situations is a point of concern in designing all of RBS which can be addressed using the proposed method.

Implementing the Eco-Regen system with a CVT increases the initial cost of the vehicle which is a main challenge. However, a cost-benefit analysis tailored to the vehicle's application can demonstrate that the energy efficiency gains justify these additional costs, particularly in urban drive cycles characterized by frequent stop-and-go situations. A typical urban driving cycle such as ECE 15 averages four stops per kilometer. In such settings, with varied speeds and short stopping distances, the study estimates up to a 38% range increase, as shown in Table 4. Additionally, using a CVT during acceleration could extend the range by another 10.1%, resulting in a potential total range increase of up to 48.1%. The cost-benefit analysis, based on data from Oak Ridge National Laboratory and other studies, is presented in Table 6. This analysis excludes costs for components common to both the baseline EV and the proposed solutions, such as the vehicle's glide, electric motor, and batteries.

TABLE 5
Comparison of HIL and SIL implementations

| Scenario | | Recovered SOC (RSOC) | | | | | |
|---|---|---|---|---|---|---|---|
| Distance | Initial | Human Driver | | Automated | | Proposed Solution | |
| to final | Speed | RSOC | RSOC | RSOC | RSOC | RSOC | RSOC |
| stop (m) | (m/s) | HIL (%) | SIL (%) | HIL (%) | SIL (%) | HIL (%) | SIL (%) |
| 70 | 10 | 0.027 | 0.035 | 0.029 | 0.037 | 0.031 | 0.039 |
| 50 | | 0.027 | 0.035 | 0.029 | 0.038 | 0.032 | 0.039 |
| 30 | | 0.025 | 0.034 | 0.028 | 0.036 | 0.031 | 0.039 |
| 70 | 15 | 0.071 | 0.080 | 0.074 | 0.083 | 0.081 | 0.089 |
| 50 | | 0.068 | 0.079 | 0.070 | 0.075 | 0.084 | 0.090 |
| 30 | | 0.058 | 0.067 | 0.059 | 0.064 | 0.084 | 0.089 |
| 70 | 20 | 0.111 | 0.125 | 0.121 | 0.142 | 0.138 | 0.158 |
| 50 | | 0.072 | 0.088 | 0.097 | 0.106 | 0.131 | 0.143 |
| 30 | | 0.052 | 0.061 | 0.058 | 0.064 | 0.095 | 0.103 |

It is reasonable to assume that the Eco-Regen system would not add significant costs for perception. This is because it leverages existing onboard sensors and actuators already used for ADAS by vehicle manufacturers. Given that the primary difference among the three vehicle structures studied is the gearbox, the projected lifetime maintenance costs for the vehicles are anticipated to be comparable. Gearbox maintenance is relatively infrequent, typically requiring a transmission oil change every 100,000 kin, unlike more frequent tasks such as tire and brake replacements, electronic system servicing, and routine inspections. Consequently, the gearbox contributes minimally to the overall maintenance expenses. Moreover, recently, certain manufacturers have offered maintenance-free CVT systems. A maintenance-free CVT can address a key challenge of adding a CVT to an EV.

Based on the experimental study, the additional mass from CVT implementation does contribute to higher energy consumption, which is accounted for in the average energy consumption calculations in Table 6.

TABLE 6
Cost-benefit analysis table based on vehicle
model characteristics presented in Table 3

| | | | EV with |
|---|---|---|---|
| | Baseline | EV with basic | advanced |
| Vehicle parameter | EV | Eco-Regen | Eco-Regen |
| Vehicle lifetime | 300,000 | 300,000 | 300,000 |
| mileage (km) | | | |
| Vehicle weight (kg) | 1500 | 1500 | 1580 |
| Added hardware costs | 0 | 0 | ≈1562 |
| (US$) | | | |
| Expected range (km) | 230 | 269.1 | 340.4 |
| Energy consumption | 17.03 | 15.14 | 12.42 |
| (kWh/100 km) | | | |
| Total energy cost in | 11240 | 9992.4 | 8197.2 |
| lifetime (USD) | | | |
| Total costs in lifetime | 11240 | 9992.4 | 9759 |
| (US$) | | | |

As shown in Table 6, the cost-benefit analysis indicates that the average charging costs for level 2 chargers not only offset the initial investment but also provide a net benefit for this system. However, EV users cannot always charge exclusively with level 2 chargers. In some situations, they may need to use fast chargers, which come with higher electricity rates and can significantly increase charging costs over time. Even if users avoid fast chargers to save on costs, they may face indirect expenses, such as lost time, especially when the EV is used for business or commercial purposes. The electricity costs for charging EVs via DC fast chargers are significantly higher. Therefore, when considering a mix of different charger types, the total charging costs are expected to rise, as illustrated in Table 7.

TABLE 7
Cost-benefit analysis considering average electricity
rates, including level 1, level 2, and fast chargers

| | | | EV with |
|---|---|---|---|
| | Baseline | EV with basic | advanced |
| Vehicle parameter | EV | Eco-Regen | Eco-Regen |
| Vehicle lifetime | 300,000 | 300,000 | 300,000 |
| mileage (km) | | | |
| Vehicle weight (kg) | 1500 | 1500 | 1580 |
| Added hardware costs | 0 | 0 | ≈1562 |
| (US$) | | | |
| Expected range (km) | 230 | 269.1 | 340.4 |
| Energy consumption | 17.03 | 15.14 | 12.42 |
| (kWh/100 km) | | | |
| Total energy cost in | 17,881.5 | 15,897 | 13,041 |
| lifetime (USD) | | | |
| Total costs in lifetime | 11240 | 9992.4 | 9759 |
| (US$) | | | |

Based on the results of Table 7, the Eco-Regen system can offset its initial costs and generate a positive net value over the vehicle's lifetime. Although CVTs are not commonly used in EVs today, the analysis demonstrates that integrating this architecture with the proposed Eco-Regen system and controller can overcome current challenges. By optimizing energy efficiency and extending vehicle range, this approach makes the application of CVTs in EVs not only feasible but also advantageous, particularly in urban transit scenarnos.

### 6. Conclusion

This paper introduces the Eco-Regen system, a multi-layered controller designed to optimize energy recapture during braking. The Eco-Regen system efficiently manages the entire braking process, maximizing regenerated energy without extending braking time. A pivotal feature of the proposed system is the integration of a variable gear ratio, which can be implemented using existing CVT technologies. The results from the proposed controllers indicate that the Eco-Regen system holds significant potential to improve overall EV efficiency and range.

The results show that human driver behavior significantly affects RBS effectiveness. To investigate this further, the study used an average human driver model to assess its impact on energy efficiency. This model was then used to compare automated braking systems with the proposed Eco-Regen method.

Current RBSs struggle to handle a wide range of driving maneuvers effectively. As highlighted in Section 5 and shown in Table 5, both experimental and simulation analyses demonstrate that conventional RBS are most effective during low-deceleration scenarios, primarily useful for coasting. However, real driving cycles, especially urban ones, involve higher deceleration rates where traditional RBS fail to capture much of the vehicle's kinetic energy. The results in Table 5 show that energy savings of up to 61% can be achieved with the proposed Eco-Regen system without extending the total braking time.

The Eco-Regen system is designed to function effectively in both deceleration and full-stop maneuvers. This is achievable by programming the controllers to generate appropriate brake signals based on the desired maneuvers and upcoming events. While the current implementation of Eco-Regen relies on advanced data about upcoming events, it can be programmed to operate without prior knowledge. In such scenarios, the Eco-Regen can respond to torque demands from either the human driver or automated driving features. Although this reactive mode may not be as efficient as the automated braking method that uses advanced information, it still offers significant energy savings due to the actions of FLGRC.

The cost-benefit analysis in Section 5.5 shows that the energy savings over the vehicle's lifetime not only cover the initial costs of the additional components but also yield a return of twice the initial investment. These savings are in addition to the range extension and environmental benefits provided by the proposed method.

While the proposed method's effectiveness and applicability were verified through HIL testing in Section 5.4, further validation in broader scenarios could be gained through experimental analysis in real-world EV applications.

### CONCLUSION

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A system to facilitate regenerative braking of a vehicle, the system comprising:
an electric machine coupled to a wheel of the vehicle;
a distance sensor coupled to a portion of the vehicle, the distance sensor configured to provide distance information indicative of a distance to a stop location for the vehicle;
a torque sensor configured to provide torque information indicative of a torque between the electric machine and the wheel;
a speed sensor configured to provide speed information indicative of a speed of the electric machine or a speed of the vehicle; and
a controller comprising a processor and a memory storing instructions thereon that, when executed by the processor, cause the processor to:
send a query to a stored map that includes energy efficiency information corresponding to the vehicle, the query including the distance information and the speed information;
output a desired braking torque from the map based on the query and a maximum possible energy efficiency value of the stored map;
control operation of the electric machine based on the torque information and the desired braking torque.

2. The system of claim 1, wherein the maximum possible energy efficiency value of the stored map or the distance to a stop location is continuously updated as the vehicle moves.

3. The system of claim 1, wherein the processor is further configured to identify the stop location of the vehicle, calculate the distance to the identified stop location, and continuously update the distance to the stop location based on the maximum possible energy efficiency value of the stored map.

4. The system of claim 1, wherein the distance sensor continuously updates the distance to the stop location, and the speed sensor continuously updated the speed of the electric machine or the speed of the vehicle.

5. The system of claim 1, wherein the processor continuously updates a desired braking distance based on the desired braking torque and the speed information and controls operation of the electric machine based on the desired braking distance.

6. The system of claim 1, wherein the processor:
sends a second query to the stored map including updated distance and speed information;
outputs an updated desired braking torque from the map based on the second query; and
controls operation of the electric machine based on the updated desired braking torque and the torque information.

7. The system of claim 1, wherein the processor is further configured to generate a braking procedure based on the desired braking torque.

8. The system of claim 7, wherein the processor initiates an alert system to generate at least one notification based on the braking procedure.

9. The system of claim 7, wherein controlling operation of the electric machine includes initiating a brake coupled to the wheel of the vehicle to apply a braking force corresponding to the braking procedure.

10. The system of claim 1, wherein controlling operation of the electric machine includes initiating a brake coupled to the wheel of the vehicle to apply a braking force corresponding to the desired braking torque, the brake causing a torque input to the electric machine and a battery coupled thereto.

11. A system to facilitate regenerative braking of a vehicle, the system comprising:
an electric machine;
a gearbox coupled between the electric machine and a wheel of the vehicle, the gearbox being controllable to adjust a gear ratio between the electric machine and the wheel;
a distance sensor coupled to a portion of the vehicle, the distance sensor configured to provide distance information indicative of a distance to a stop location for the vehicle;
a torque sensor configured to provide torque information indicative of a torque between the electric machine and the wheel;
a speed sensor configured to provide speed information indicative of a speed of the electric machine or a speed of the vehicle; and
a controller comprising a processor and a memory storing instructions thereon that, when executed by the processor, cause the processor to:
send a query to a stored map that includes energy efficiency information corresponding to the vehicle, the query including the distance information and the speed information;
output a desired braking torque from the map based on the query and a maximum possible energy efficiency value of the stored map;
control operation of the electric machine or the gearbox based on the torque information and the desired braking torque.

12. The system of claim 11, wherein the processor controls operation of the gearbox based on the torque information, wherein the torque information is continuously updated during application of a brake to the wheel.

13. The system of claim 12, wherein the processor is reactive to application of the brake via a user of the vehicle.

14. The system of claim 11, wherein the gearbox is a continuously variable transmission.

15. The system of claim 11, wherein the processor further controls operation of the electric machine and the gearbox based on the desired braking torque and the distance to the stop location, the processor configured to cause the gearbox to change the gear ratio to match a desired gear ratio corresponding to the desired braking torque.

16. The system of claim 11, wherein the processor is further configured to generate a braking procedure based on the desired braking torque, wherein the braking procedure includes at least one gear ratio of the gearbox.

17. The system of claim 11, wherein controlling operation of the electric machine includes initiating a brake coupled to the wheel of the vehicle to apply a braking force corresponding to the desired braking torque, the brake causing a torque input to the electric machine and a battery coupled thereto.

18. A method of regenerative braking, the method comprising:
providing an electric machine coupled to a wheel of a vehicle;
providing distance information, via a distance sensor coupled to a portion of the vehicle, indicative of a distance to a stop location for the vehicle;
providing torque information, via a torque sensor, indicative of a torque between the electric machine and the wheel;
providing speed information, via a speed sensor, indicative of a speed of the electric machine or a speed of the vehicle;
sending a query, via a processor of a controller that includes a memory, to a stored map that includes energy efficiency information corresponding to the vehicle, the query including the distance information and the speed information;
outputting a desired braking torque from the map based on the query and a maximum possible energy efficiency value of the stored map; and
controlling operation of the electric machine based on the torque information and the desired braking torque.

19. The method of claim 18, further comprising:
performing, via a brake coupled to the vehicle, a braking operation corresponding to the desired braking torque; and
recharging a battery coupled to the electric machine based on the braking operation.

20. The method of claim 18, further comprising:
providing a gearbox coupled between the electric machine and a wheel of the vehicle;
calculating a desired gear ratio based on the distance to the stop location and the desired braking torque; and
adjusting the gear ratio of the gearbox.
